(19) United States
(12) Patent Application Publication
(10) Pub. No.: US 2026/0254508 A1
(43) Pub. Date: Aug. 27, 2026

(54) SYSTEMS, METHODS, AND DEVICES FOR CSI-RS RESOURCE SETTING

(71) Applicant: Apple Inc., Cupertino, CA (US)

(72) Inventors: Ankit BHAMRI, Haar (DE); Haitong SUN, Saratoga, CA (US); Wei ZENG, Saratoga, CA (US); Dawei ZHANG, Saratoga, CA (US)

(21) Appl. No.: 19/545,881

(22) Filed: Feb. 20, 2026

Related U.S. Application Data
(60) Provisional application No. 63/761,791, filed on Feb. 21, 2025.

(51) Int. Cl. H04B 7/06; H04L 5/00

(52) U.S. Cl. CPC H04B 7/0626; H04B 7/06952; H04L 5/0007

(57) ABSTRACT

Described herein are solutions for channel state information (CSI) reference signal (CSI-RS) resource setting. A network can be configured to support CSI-RS resources for communicating a CSI-RS between a base station and a user equipment (UE) at a same orthogonal frequency division multiplexing (OFDM) symbol. CSI-RS resources mapped to a same OFDM symbol can use non-overlapping frequencies, and/or can be associated with different beams. For example, a base station can transmit using CSI-RS resources at a same OFDM symbol using different frequencies for each CSI-RS resource via different transmission beams. The frequencies of the CSI-RS resources can be defined relative to one or more reference resource block (RB) locations in a frequency domain or based on offsets applied to the one or more reference RB locations.

### CROSS REFERENCE TO RELATED APPLICATIONS

This application claims the benefit of U.S. Provisional Application No. 63/761,791, filed February 21, 2025, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fifth generation (5G) or new radio (NR) technology, sixth generation (6G) technology, and so on. Such technology can include solutions related to frequency selective beamforming, in which beams can be communicated concurrently at different frequencies. For example, multiple beams can be transmitted from a base station during a same orthogonal frequency division multiplexing (OFDM) symbol (e.g., of a slot), based on each beam being associated with a different frequency range. In some examples, the base station can support joint phase time array (JPTA) beamforming to facilitate frequency selective analog beams. In some examples, the base station can alternatively implement sub-array based beamforming to facilitate frequency selective beamforming.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to "an" or “one” aspect, implementation, etc., may not necessarily refer to the same aspect, implementation, etc., and can mean at least one, one or more, etc.

FIG. 1 is a diagram of an example of an overview according one or more implementations described herein.

FIG. 2 is a diagram of example environment according to one or more implementations described herein.

FIG. 3 is a diagram of an example network configuration for channel state information (CSI) reference signal (CSI-RS) resources according to one or more implementations described herein.

FIGS. 4A and 4B are diagrams of example CSI-RS resource configurations for mapping multiple CSI-RS resources to a same orthogonal frequency division multiplexing (OFDM) symbol according to one or more implementations described herein.

FIGS. 5A and 5B are diagrams of example CSI-RS resource configurations for defining CSI-RS resources according to one or more implementations described herein.

FIGS. 6A, 6B, 6C, and 6D are diagrams of example beam configurations associated with CSI-RS resources according to one or more implementations described herein.

FIG. 7 is a diagram of an example combined configuration for mapping CSI-RS resources and synchronization signal block (SSB) resources to a same OFDM symbol according to one or more implementations described herein.

FIG. 8 is a diagram of an example of components of a device configured to support CSI-RS resource setting according to one or more implementations described herein.

FIG. 9 is a diagram of example interfaces of baseband circuitry configured to support CSI-RS resource setting according to one or more implementations described herein.

FIG. 10 is a block diagram illustrating components, according to one or more implementations described herein, able to read instructions from a machine-readable or computer-readable medium (e.g., a non-transitory machine-readable storage medium) and perform any one or more of the methodologies supporting CSI-RS resource setting, as discussed herein.

FIG. 11 is a diagram of an example process for CSI-RS resource setting according to one or more implementations described herein.

FIG. 12 is a diagram of an example process for CSI-RS resource setting according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Wireless communication networks can include user equipment (UE) capable of communicating with base stations and/or other network devices. UEs and base stations can implement various techniques and communications standards for enabling UEs and base stations to discover one another, establish and maintain connectivity, and exchange information in an ongoing manner. For example, UEs and base stations can be configured to communicate based on beamforming, in which beams associated with directional signaling can be generated, transmitted, and received between UEs and base stations.

Base stations and UEs can be configured to support determining channel state information (CSI). For example, a base station can be configured to transmit a CSI reference signal (CSI-RS) and the UE can be configured to perform one or more measurements based on the CSI-RS. The UE can determine CSI based on performing the one or more measurements and transmit an indication of the determined CSI (e.g., as a CSI report, as part of CSI reporting) to the base station. The CSI-RS (e.g., or additional CSI-RSs) can be transmitted using a set of CSI-RS resources (e.g., a CSI-RS resource set), which the UE can use for performing the one or more measurements. That is, a set of CSI-RS resources can be associated with communicating a single CSI-RS, or a set of CSI-RS resources can be associated with communicating multiple CSI-RSs. For example, each CSI-RS resource of a CSI-RS resource set can be associated with communicating a respective portion of a CSI-RS.

Some networks can support configurations of CSI-RS patterns that can be associated with the CSI-RS resources of a CSI-RS resource set, or associated with a pattern for communicating via CSI-RS resources between UEs and base stations of a respective network. In some examples, configuration parameters can be supported by the network for configuring CS-RS resources or CSI-RS patterns, including a repetition parameter, among others. In some implementations, a UE can identify that each CSI-RS resource of a CSI-RS resource set is configured with a same starting resource block (RB) and number of RBs, and a same code-division multiplexing type (e.g., cdm-type).

Some networks can support frequency selective beamforming, where beams of different frequency resources yet similar time resources can be communicated between UEs and base stations. Frequency selective beamforming can include concurrently (e.g., at least partially overlapping in the time domain) transmitting multiple beams from a base station, where each beam is associated with a different frequency range (e.g., sub-band, set of sub-carriers, bandwidth part (BWP)). For example, two or more beams can be transmitted in a same orthogonal frequency division multiplexing (OFDM) symbol based on each beam being associated with a different frequency range. A frequency range can also be referred to herein as a frequency resource (e.g., sub-band, set of sub-carriers, BWP, etc.). In some examples, implementing frequency selective beamforming can provide reduced latency associated with beam access and beam refinement or tracking based on multiple beams being transmitted concurrently. In some examples, implementing frequency selective beamforming can additionally reduce beam squinting.

In some implementations (e.g., for frequency range 2 (FR2) beamforming), a base station can implement an architecture which supports frequency selective beamforming. For example, a base station can implement joint phase time array (JPTA) based beamforming or sub-array based beamforming. An architecture supporting JPTA based beamforming can apply a time delay corresponding to each antenna element or group of antenna elements, which can support frequency selective analog beams. An architecture supporting sub-array based beamforming can include each sub-array (e.g., of antenna elements) being coupled with (e.g., connected to) a respective radio frequency (RF) chain and corresponding phase shifters.

In some examples, implementing frequency selective beamforming can adversely affect an ability of network devices to support certain network operations. For example, a UE may not implement an architecture (e.g., JPTA) configured to support frequency selective beamforming. Thus, the UE may not be configured to support operations or signaling using frequency selective beamforming. For example, implementing frequency selective beamforming for communicating CSI-RSs can affect the UE’s ability to support receiving the CSI-RS. That is, to support frequency selective beamforming for communicating CSI-RSs to the UE, CSI-RS resources within a CSI-RS resource set can require reconfiguration and/or remapping within the frequency domain. Thus, enhancing a beam management framework of a network to enable frequency selective beamforming for communicating CSI-RSs to a UE can be desirable.

One or more techniques described herein can support communicating, to a UE, CSI-RSs using frequency selective beamforming. In accordance with examples as described herein, CSI-RS resources can be reconfigured to support frequency selective beamforming. That is, multiple CSI-RS resources can be mapped to a same OFDM symbol, based on CSI-RS resources being associated with different frequencies. For example, CSI-RS resources of a CSI-RS resource set can be mapped such that a subset (e.g., or all) of the CSI-RS resources are associated with a same OFDM symbol (e.g., and another subset of the CSI-RS resources are associated with another OFDM symbol).

Such techniques can utilize one or more reference RBs for configuring the CSI-RS resources of a CSI-RS resource set. For example, a location (e.g., a frequency) of a reference RB can be configured for one or more CSI-RS resource sets, and offsets (e.g., frequency offsets) can be applied relative to the reference RB location to define (e.g., to configure the frequency associated with) the CSI-RS resources of the one or more CSI-RS resource sets. Further, different beams can be associated with a CSI-RS resource set. For example, different beams can be associated with different CSI-RS resources corresponding to a same OFDM symbol. Likewise, different beams can be associated with different CSI-RS resources corresponding to different OFDM symbols. In some examples, synchronization signal block (SSB) resources and CSI-RS resources can be mapped to a same OFDM symbol at different frequencies (e.g., non-overlapping frequency resources) using different beams.

The techniques described herein can enable improved support for frequency selective beamforming (e.g., by a network) associated with CSI-RS resources. The configurations described herein can enable a base station to communicate one or more CSI-RSs in accordance with frequency selective beamforming, such that a UE can support receiving the one or more CSI-RSs. Configuring the network (e.g., base stations) to support frequency selective beamforming for CSI-RS resources can provide decreased latency at network devices (e.g., for performing beam sweeping and selection), which can improve overall latency of the network.

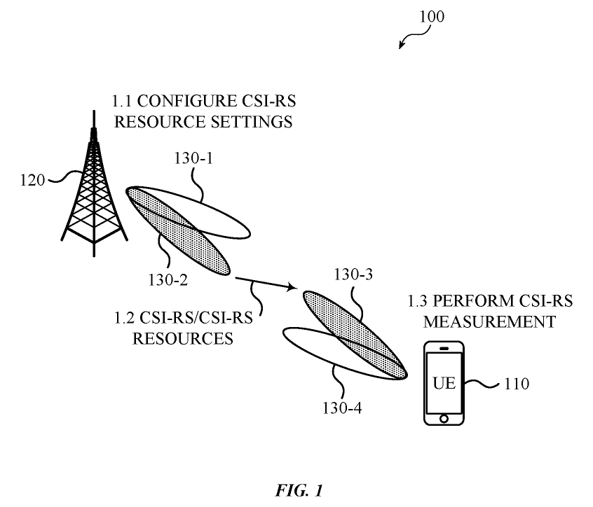

FIG. 1 is a diagram of an example of an overview 100 according to one or more implementations described herein. As shown, overview 100 includes UE 110 and base station 120. Overview 100 includes an example network which can support communicating signaling via beams 130 between base station 120 and UE 110. Some beams 130 (e.g., beam 130-1, beam 130-2) can be examples transmission beams, transmitted from base station 120 to UE 110. Other beams 130 (e.g., beam 130-3, beam 130-4) can be reception beams. The reception beams may not be formed and transmitted from UE 110 to base station 120, but rather pointed in a direction of reception, such that the reception beams are a representation of tuning one or more receivers of UE 110. In some implementations, the network can support beam sweeping and beam selection, in which multiple beams (e.g., beam 130-1, beam 130-2) can be communicated between base station 120 and UE 110, and a beam (e.g., beam 130-2) with a relatively highest signal strength or quality (e.g., or other parameter) can be selected.

Overview 100 illustrates frequency selective beamforming for communicating one or more CSI-RSs, or communicating indications of CSI-RS resources associated with the one or more CSI-RSs. The network can be configured with, or can configure, the base station with CSI-RS resource settings supporting frequency selecting beamforming (at 1.1). For example, the CSI-RS resource settings can be configured such that multiple CSI-RS resources can be mapped to a same OFDM symbol. In some examples, the CSI-RS resource settings can be transmitted to from base station 120 to UE 110, indicating the CSI-RS resources associated with one or more CSI-RSs. In other examples, the one or more CSI-RSs can be transmitted from base station 120 to UE 110 in accordance with the CSI-RS resources of the configured CSI-RS resource settings (at 1.2).

In some examples, the CSI-RS resources can be defined relative to one or more reference RB locations or offsets (e.g., equivalently spaced or independently configured offsets) applied to the one or more reference RB locations. In some examples, different beams 130 can be associated with different CSI-RS resources. In some such examples, the different beams 130 can be associated with different frequencies (e.g., different frequency ranges) associated with the different CSI-RS resources. For example, beam 130-1 can be associated with a first CSI-RS resource at an OFDM symbol, and beam 130-2 can be associated with a second CSI-RS resource at the same OFDM symbol. In some implementations, SSB resources and CSI-RS resources can be mapped to a same OFDM symbol and can be associated with different beams 130 (e.g., beam 130-1 being associated with an SSB resource, and beam 130-2 being associated with a CSI-RS resource).

In some examples, UE 110 can be configured to perform CSI-RS measurement based on receiving the CSI-RS (at 1.3). In some implementations, UE 110 can receive the one or more CSI-RSs via the CSI-RS resources and perform CSI-RS measurement on the one or more CSI-RSs. In other implementations, UE 110 can receive an indication of the CSI-RS resources, which UE 110 can use for receiving the one or more CSI-RSs. UE 110 can determine CSI associated with beams 130, and transmit indications of the CSI (e.g., CSI reports) to base station 120. In some implementations, determining CSI can support selecting a reception beam (e.g., beam 130-3, beam 130-4) or a transmission beam (e.g., beam 130-1, beam 130-2). In accordance with the techniques described herein, latency associated with performing beam sweeping and selection can be reduced, and beam squinting can be negated based on transmitting multiple beams concurrently.

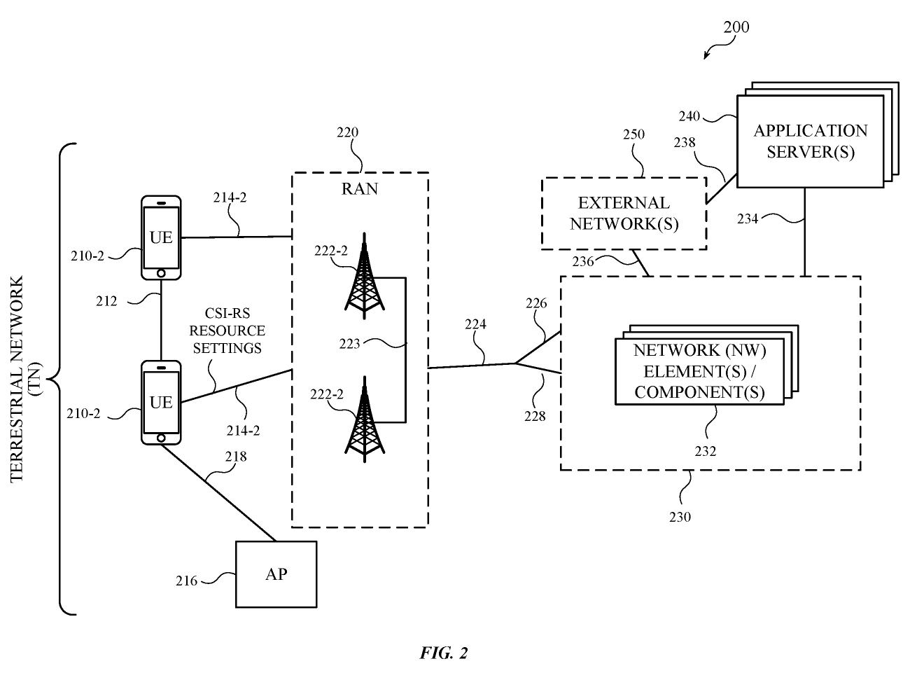

FIG. 2 is a diagram of an example environment 200 according to one or more implementations described herein. Example environment 200 may be representative of an environment in which one or more of the techniques described herein can be implemented according to various embodiments. Example environment 200 can include UEs 210-1, 210-2, etc. (referred to collectively as “UEs 210” and individually as “UE 210”), a radio access network (RAN) 220, a core network (CN) 230, application servers 240, external networks 250.

The systems and devices of example environment 200 can operate in accordance with one or more communication standards, such as 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example environment 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards, and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include Internet of Things (IoT) devices (or IoT UEs) that can implement narrowband (NB) communications and that can comprise, for example, a network access layer designed for low-power IoT applications utilizing short-lived UE connections.

Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface / layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

Various techniques for communication between and among UEs 210 in furtherance of offloading or computing operations are within the scope of the present disclosure. As described herein, in an example, UE 210 can communicate with RAN node 222 to request SL resources. RAN node 222 can respond to the request by providing UE 210 with a dynamic grant (DG) or configured grant (CG) regarding SL resources. The UE 210 can communicate with RAN node 222 using a licensed frequency band and communicate with the other UE 210 using an unlicensed or licensed frequency band. In another example, UEs 210 can communicate directly without involvement of RAN node 222, such as through resource pools, etc.

UEs 210 can communicate and establish a connection with RAN 220, which can involve one or more wireless channels 214-1 and 214-2, each of which can comprise a physical communications interface / layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 222-1 and 222-2) that can be connected via non-ideal backhaul (e.g., where one network node provides NR access and the other network node provides either E-UTRA for LTE or NR access for 5G). A network node can be referred to herein as a base station 222. In such a scenario, one network node can operate as a master node (MN) and the other as the secondary node (SN). The MN and SN can be connected via a network interface, and at least the MN can be connected to the CN 230. In some implementations, a base station (as described herein) can be an example of network node 222. In some scenarios, RAN 220 can coordinate with core network 230 via interfaces 224, 226, and/or 228.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection interface 218 can comprise a local wireless connection, such as a connection consistent with any IEEE 802.11 protocol, and AP 216 can comprise a wireless fidelity (Wi-Fi®) router or other access point device. While not explicitly depicted in FIG. 2, AP 216 can be connected to another network (e.g., the Internet) without connecting to RAN 220 or CN 230.

One or more of the techniques described herein include solutions for CSI-RS resource setting in accordance with frequency selective beamforming. That is, a network can be configured to support concurrently communicating CSI-RS (e.g., multiple CSI-RSs or portions of a single CSI-RS) between UE 210 and base station 222 based on using different frequencies and/or beams associated with the respective CSI-RS resources. For example, multiple CSI-RS resources can be mapped to a same OFDM symbol based on the CSI-RS resources being associated with different frequencies or different beams. Implementing CSI-RS resource setting can decrease latency for the network, which can improve performance, among other advantages. These and many other features and examples are described herein.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells. A RAN node can generally be referred to herein as base station 222.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 1 (L1) protocol entities can be operated by individual RAN nodes 222; a media access control (MAC) / physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information feedback from any of UEs 210. The downlink resource assignment information can be sent on the PDCCH used for (e.g., assigned to) each of UEs 210.

RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs / gNBs or a combination thereof) that connect to evolved packet core (EPC) or CN 230, or between two eNBs connecting to an EPC. As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN (5GC), and/or one or more additional or alternative types of CNs.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

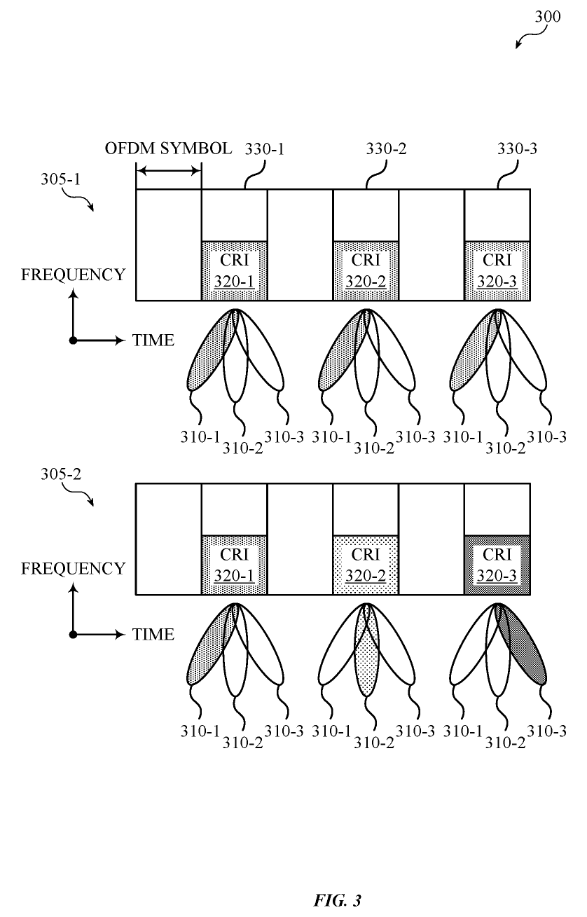

FIG. 3 is a diagram of an example network configuration 300 for CSI-RS resources according to one or more implementations described herein. Network configuration 300 illustrates operations which can be performed by a UE (e.g., UE 210) and a base station (e.g., base station 222) operable to communicate via beams 310. Beams 310 (e.g., beam 310-1, beam 310-2, beam 310-3) can be examples of beams 130. For example, beams 310 can be examples of transmission beams from a base station, such that beams 310 can be examples of beams 130-1 and 130-2.

Network configuration 300 includes configuration 305-1 and configuration 305-2, each of which illustrates a respective configuration for CSI-RS resources using beams 310. Configuration 305-1 and configuration 305-2 can each include an axis associated with the time domain (e.g., an x-axis), and an axis associated with the frequency domain (e.g., a y-axis). Likewise, configuration 305-1 and configuration 305-2 can each illustrate a quantity of OFDM symbols 330 (e.g., OFDM symbol 330-1, OFDM symbol 330-2, OFDM symbol 330-3) within the time domain. For example, the quantity of OFDM symbols 330 can be associated with a same slot for communicating signaling.

Each CSI-RS resource can be represented within network configuration 300 by a respective CSI-RS resource indicator (CRI) 320. Each CRI 320 is illustrated as occupying a respective OFDM symbol 330. Thus, it should be understood that each CSI-RS resource corresponding to a respective CRI 320 can be associated with a respective OFDM symbol 330. For example, CRI 320-1 being illustrated at OFDM symbol 330-1 should be understood as being representative of a CSI-RS resource corresponding to CRI 320-1 being mapped to OFDM symbol 330-1. Although FIG. 3 illustrates each configuration 305 including an OFDM symbol 330 between the OFDM symbols 330 associated with the CRIs 320, it should be understood that the OFDM symbols 330 associated with the CRIs 320 can be sequential. For example, an OFDM symbol 330 may not occur between OFDM symbol 330-1 and OFDM symbol 330-2.

Each CRI 320 is illustrated as occupying a frequency range of the frequency domain. Thus, it should be understood that each CSI-RS resource corresponding to a respective CRI 320 can be associated with a frequency range, such as a sub-band, a bandwidth part, or a set of subcarriers. In some such examples, the frequency domain associated with each configuration 305 can be an example of frequencies corresponding to a channel.

For each CRI 320, each configuration 305 illustrates a corresponding beam configuration. That is, each configuration 305 illustrates potential beams 310 which can be transmitted from a base station, corresponding to the respective CSI-RS resource. Each configuration 305 illustrates a selected beam 310 of the potential beams 310 which can be used to transmit the respective CSI-RS (e.g., or part of the CSI-RS) associated with the CSI-RS resource mapped to the respective OFDM symbol. For example, configuration 305-1 illustrates beam 310-1 being selected for transmitting the CSI-RS using the CSI-RS resource corresponding to CRI 320-1 and mapped to OFDM symbol 330-1.

Each configuration 305 can be associated with operations corresponding to a repetition parameter. For example, configuration 305-1 illustrates operations associated with the repetition parameter being set to “ON,” and configuration 305-2 illustrates operations associated with the repetition parameter being set to “OFF.” The repetition parameter being set to “ON” can be otherwise referenced as a P3 type operation. The repetition parameter being set to “OFF” can be otherwise referenced as a P2 type operation.

Configuration 305-1 illustrates using a same beam 310-1 for each CSI-RS resource. That is, a same downlink (DL) spatial filter (e.g., beam 310) can be applied at a base station for every CSI-RS resource within a CSI-RS resource set. For example, each CSI-RS resource can be mapped to a different OFDM symbol 330. Because the repetition parameter is set to “ON,” the beam 310 associated with the CSI-RS resources can be repeatedly used for different OFDM symbols 330. In some examples, configuration 305-1 can support beam sweeping at a UE, which can include testing different reception beams to determine a beam with a relatively highest signal strength or quality. For example, one or more CSI-RSs can be received over one or more CSI-RS resources, and the one or more CSI-RSs can be used to perform measurements to determine which reception beam should be used.

Configuration 305-2 illustrates using a different beam 310 for each CSI-RS resource. That is, a different downlink (DL) spatial filter (e.g., beam 310) can be applied at a base station for every CSI-RS resource within a CSI-RS resource set. For example, beam 310-1 can be associated with the CSI-RS resource corresponding to CRI 320-1, which is mapped to OFDM symbol 330-1. In some such examples, beam 310-2 can be associated with the CSI-RS resource corresponding to CRI 320-2, which is mapped to OFDM symbol 330-2. Likewise, beam 310-3 can be associated with the CSI-RS resource corresponding to CRI 320-3, which is mapped to OFDM symbol 330-3. In some implementations, each CSI-RS resource can be mapped to a different OFDM symbol 330. Because the repetition parameter is set to “OFF,” the beam 310 selected for transmission of the CSI-RS (e.g., or portion of the CSI-RS) via the CSI-RS resources may not be repeatedly used for the CSI-RS resources mapped to different OFDM symbols 330. In some examples, configuration 305-2 can support beam sweeping at a base station, which can include testing different transmission beams to determine a beam with a relatively highest signal strength or quality. For example, one or more CSI-RSs can be transmitted over one or more CSI-RS resources, and the one or more CSI-RSs can be used to perform measurements to determine which transmission beam should be used.

Network configuration 300 illustrates different configurations 305 for transmitting beams 310 associated with different CSI-RS resources, which can support beam sweeping and selection, among other operations. Additionally, network configuration 300 can support CSI-RS resource setting as described herein. The configurations 305 can support frequency selective beamforming directed to CSI-RS resources corresponding to CRIs 320. For example, the techniques described herein support communicating CSI-RSs in accordance with multiple CSI-RS resources mapped to a same OFDM symbol 330, based on using different frequencies. Likewise, different beams 310 can be used for communicating during the same OFDM symbol 330, or across multiple OFDM symbols 330, which can support frequency selective beamforming techniques at a base station and a UE. For example, beam 310-1 and beam 310-2 can be used to communicate during OFDM symbol 330-1, based on multiple CSI-RS resources being mapped to OFDM symbol 330-1.

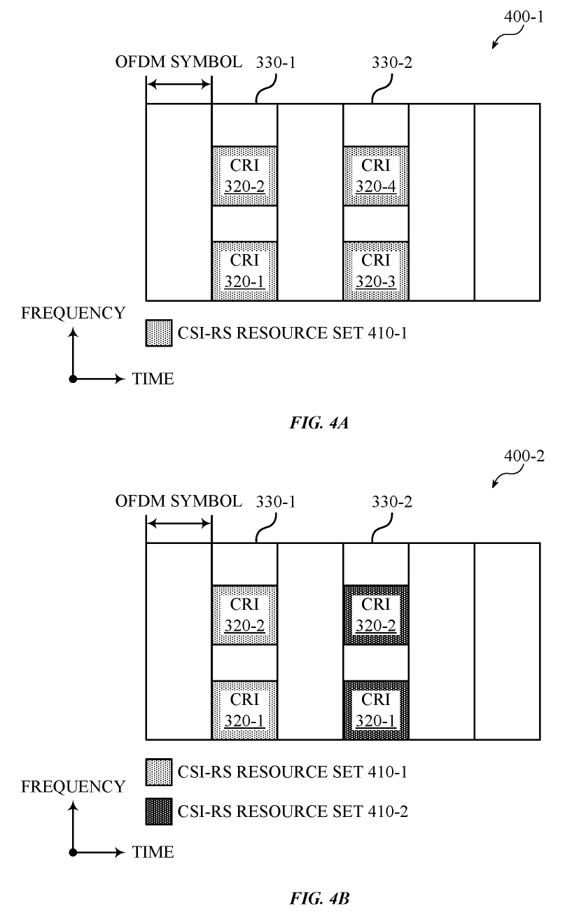

FIGS. 4A and 4B are diagrams of example CSI-RS resource configurations 400 for mapping multiple CSI-RS resources to a same OFDM symbol according to one or more implementations described herein. CSI-RS resource configurations 400 (e.g., CSI-RS resource configuration 400-1, CSI-RS resource configuration 400-2) can be implemented by a network, including one or more network devices, which can be examples of UE 210 and base station 222. CSI-RS resource configurations 400 each include axes associated with the time domain and the frequency domain. CSI-RS resource configurations 400 each include a quantity of OFDM symbols 330 (e.g., OFDM symbol 330-1, OFDM symbol 330-2) within the time domain. It should be understood that for each CSI-RS resource configuration 400, the OFDM symbols 330 can be sequential, such that an OFDM symbol 330 may not occur between OFDM symbol 330-1 and OFDM symbol 330-2. Likewise, each CSI-RS resource can be represented by a respective CRI 320.

CSI-RS resource configuration 400-1 illustrates CSI-RS resource settings associated with mapping multiple CSI-RS resources of CSI-RS resource set 410-1 to a same OFDM symbol 330. In some examples, CSI-RS resource set 410-1 can be configured with multiple CSI-RS resources up to M, in which at least a subset of the CSI-RS resources up to N (e.g., where N is less than or equal to M) are mapped to a same OFDM symbol 330 (e.g., OFDM symbol 330-1). In some such examples, the remaining subset of CSI-RS resources can be mapped to one or more other OFDM symbols 330 (e.g., OFDM symbol 330-2). In some implementations, the quantity of CSI-RS resources mapped to a same OFDM symbol 330 can be configured based on a capability of the UE (e.g., UE 210).

That is, CSI-RS resource configuration 400-1 supports CSI-RS resource set 410-1 with a quantity of CSI-RS resources (e.g., quantity M), in which a sub-quantity (e.g., a lesser or equal quantity, one or more) of CSI-RS resources (e.g., quantity N) are configured to be associated with a same OFDM symbol 330 (e.g., OFDM symbol 330-1). Additionally, the remaining quantity of CSI-RS resources are configured to be associated with one or more other OFDM symbols 330 (e.g., OFDM symbol 330-2).

For example, the CSI-RS resources corresponding to CRI 320-1, CRI 320-2, CRI 320-3, and CRI 320-4 can be associated with CSI-RS resource set 410-1. In some such examples, the CSI-RS resources corresponding to CRI 320-1 and CRI 320-2 can be mapped to OFDM symbol 330-1, and the CSI-RS resources corresponding to CRI 320-3 and CRI 320-4 can be mapped to OFDM symbol 330-2. That is, CRI 320-1 and CRI 320-2 can be associated with the subset of CSI-RS resources (e.g., N) of CSI-RS resource set 410-1 (e.g., M), and CRI 320-3 and CRI 320-4 can be associated with the remaining CSI-RS resources (e.g., the remaining of M). Although not shown in CSI-RS resource configuration 400-1, it should be understood that one or more of the remaining CSI-RS resources can be transmitted at another OFDM symbol 330. In some implementations, one or more CSI-RS resources of CSI-RS resource set 410-1 can be mapped to a same OFDM symbol 330 as one or more CSI-RS resources of another CSI-RS resource set 410 (e.g., not shown in CSI-RS resource configuration 400-1).

The CSI-RS resources of CSI-RS resource configuration 400-1 can be associated with different frequencies for a same OFDM symbol 330 to facilitate transmitting one or more CSI-RSs (e.g., portions of a CSI-RS based on each CSI-RS resource being associated with a portion of a CSI-RS, multiple CSI-RSs based on each CSI-RS resource being associated with a respective CSI-RS) at the OFDM symbol 330. For example, each CSI-RS resource can be associated with a frequency range. Further, each CSI-RS resource can be offset within the frequency domain. For example, the CSI-RS resource corresponding to CRI 320-1 can be associated with a frequency range, and the CSI-RS resource corresponding to a CRI 320-2 can be associated with a different frequency range. In some implementations, the CSI-RS resources may not overlap within the frequency domain for a same OFDM symbol 330, such that the frequency range associated with one CSI-RS resource may not be associated with another CSI-RS resource mapped to the same OFDM symbol 330.

In some examples, CSI-RS resources of CSI-RS resource set 410-1 can be associated with similar frequencies for different OFDM symbols 330. For example, the CSI-RS resource corresponding to CRI 320-1 can be associated with a frequency range, and the CSI-RS resource corresponding to CRI 320-3 can be associated with the same frequency range. This can be based on the CSI-RS resources corresponding to CRI 320-1 being mapped to a different OFDM symbol 330 (e.g., OFDM symbol 330-1, rather than OFDM symbol 330-2) from the CSI-RS resource corresponding to CRI 320-3.

CSI-RS resource configuration 400-2 illustrates CSI-RS resource settings associated with mapping multiple CSI-RS resources of different CSI-RS resource sets 410 to same respective OFDM symbols 330. For example, CSI-RS resource configuration 400-2 supports multiple CSI-RS resources of CSI-RS resource set 410-1 being mapped to OFDM symbol 330-1 and multiple CSI-RS resources of CSI-RS resource set 410-2 being mapped to OFDM symbol 330-2. In some examples, CSI-RS resource set 410-1 can be configured with multiple CSI-RS resources up to M, in which all CSI-RS resources (e.g., M) of CSI-RS resource set 410-1 are mapped to a same OFDM symbol 330 (e.g., OFDM symbol 330-1). In some such examples, CSI-RS resource set 410-2 can be configured with multiple CSI-RS resources up to M, in which all CSI-RS resources (e.g., M) of CSI-RS resource set 410-2 are mapped to a same OFDM symbol 330 (e.g., OFDM symbol 330-2). That is, separate CSI-RS resource sets 410 can be configured for separate OFDM symbols 330.

For example, CSI-RS resource configuration 400-2 supports CSI-RS resource set 410-1 with a quantity of CSI-RS resources (e.g., quantity M), in which the quantity of CSI-RS resources (e.g., quantity M) are configured to be associated with a same OFDM symbol 330 (e.g., OFDM symbol 330-1). Additionally, CSI-RS resource configuration 400-2 supports CSI-RS resource set 410-2 with a quantity of CSI-RS resources (e.g., quantity M), in which the quantity of CSI-RS resources (e.g., quantity M) are configured to be associated with a same OFDM symbol 330 (e.g., OFDM symbol 330-2). For example, the CSI-RS resources corresponding to CRI 320-1 and CRI 320-2 of CSI-RS resource set 410-1 can be mapped to OFDM symbol 330-1, and the CSI-RS resources corresponding to CRI 320-1 and CRI 320-2 of CSI-RS resource set 410-2 can be mapped to OFDM symbol 330-2. In some examples, the CSI-RS resources of CSI-RS resource set 410-1 can be associated with a CSI-RS, and the CSI-RS resources of CSI-RS resource set 410-2 can be associated with a different CSI-RS. In other examples, each CSI-RS resource of CSI-RS resource set 410-1 can be associated with a respective CSI-RS.

The CSI-RS resources of CSI-RS resource configuration 400-2 can be associated with different frequencies for a same OFDM symbol 330 to facilitate mapping multiple CSI-RS resources to the same OFDM symbol 330. For example, the CSI-RS resource corresponding to CRI 320-1 can be associated with a frequency range, and the CSI-RS resource corresponding to a CRI 320-2 can be associated with a different frequency range. In some implementations, the CSI-RS resources may not overlap within the frequency domain for a same OFDM symbol 330, such that the frequency range associated with one CSI-RS resource may not be associated with another CSI-RS resource mapped to the same OFDM symbol 330.

In some examples, CSI-RS resources of different CSI-RS resource sets 410 can be associated with similar frequencies. For example, the CSI-RS resource corresponding to CRI 320-1 of CSI-RS resource set 410-1 can be associated with a frequency range, and the CSI-RS resource corresponding to CRI 320-1 of CSI-RS resource set 410-2 can be associated with the same frequency range. This can be based on the CSI-RS resources corresponding to CRI 320-1 of CSI-RS resource set 410-1 being mapped to a different OFDM symbol 330 (e.g., OFDM symbol 330-1, rather than OFDM symbol 330-2) than the CSI-RS resource corresponding to CRI 320-1 of CSI-RS resource set 410-2.

For both CSI-RS resource configuration 400-1 and 400-2, a network can be configured to support the respective CSI-RS resource settings. For example, a base station can be configured to transmit CSI-RSs, in accordance with the CSI-RS resource configuration 400-1. That is, the base station can transmit, to the UE, one or more CSI-RSs (e.g., or portions of a single CSI-RS) associated with CSI-RS resource set 410-1 at a same OFDM symbol 330-1, and one or more remaining CSI-RSs (e.g., or portions of a single CSI-RS) of CSI-RS resource set 410-1 at another OFDM symbol 330-2. In some implementations, the base station can also transmit indications of the CSI-RS resources, which can be used to support receiving the one or more CSI-RSs via the CSI-RS resources. The UE can be configured to support receiving the one or more CSI-RSs or the indications of the CSI-RS resources in accordance with the CSI-RS resource configuration 400-1. After receiving the one or more CSI-RSs, the UE can be configured to perform CSI measurement to determine CSI. For example, the CSI can be associated with one or more beams transmitting the one or more CSI-RSs. In some implementations, the UE can perform RSRP and/or SINR measurement (e.g., L1-RSRP measurement and L1-SINR measurement) based on the CSI-RS resources. After determining the CSI, the UE can perform CSI reporting to the base station, which the base station can use for beam selection, among other operations.

Alternatively, a base station can be configured to transmit CSI-RSs in accordance with the CSI-RS resource configuration 400-2. That is, the base station can transmit, to the UE, using all the CSI-RS resources (e.g., CR 320-1, CR 320-2) of CSI-RS resource set 410-1, which can be mapped to a same OFDM symbol 330-1. Likewise, the base station can transmit, to the UE, using all the CSI-RS resources (e.g., CR 320-1, CR 320-2) of CSI-RS resource set 410-2, which can be mapped to another OFDM symbol 330-2. In some implementations, the base station can also transmit indications of the CSI-RS resources, which can be used to support receiving the one or more CSI-RSs via the CSI-RS resources. The UE can be configured to support receiving the one or more CSI-RSs or the indications of the CSI-RS resources in accordance with the CSI-RS resource configuration 400-2. After receiving the CSI-RS resources, the UE can be configured to perform CSI measurement to determine CSI. For example, the CSI can be associated with one or more beams transmitting the one or more CSI-RSs. In some implementations, the UE can perform RSRP and/or SINR measurement (e.g., L1-RSRP measurement and L1-SINR measurement) based on the CSI-RS resources. After determining the CSI, the UE can perform CSI reporting to the base station, which the base station can use for beam selection, among other operations.

In accordance with examples as described herein, CSI-RS resource configurations 400 can support multiple CSI-RS resources of a CSI-RS resource set being associated with a same OFDM symbol 330. Additionally, CSI-RS resource configuration 400-1 can support multiple subsets of CSI-RS resources being mapped to different respective OFDM symbols 330. Further, CSI-RS resource configuration 400-2 can support an entire set of CSI-RS resources (e.g., CSI-RS resource set 410-1) being mapped to a same OFDM symbol 330, and another set of CSI-RS resources (e.g., CSI-RS resource set 410-2) being mapped to another same OFDM symbol 330. Supporting multiple CSI-RS resources at a same OFDM symbol 330 can provide reduced latency for a network based on utilizing concurrent signaling, thereby improving performance, among other advantages.

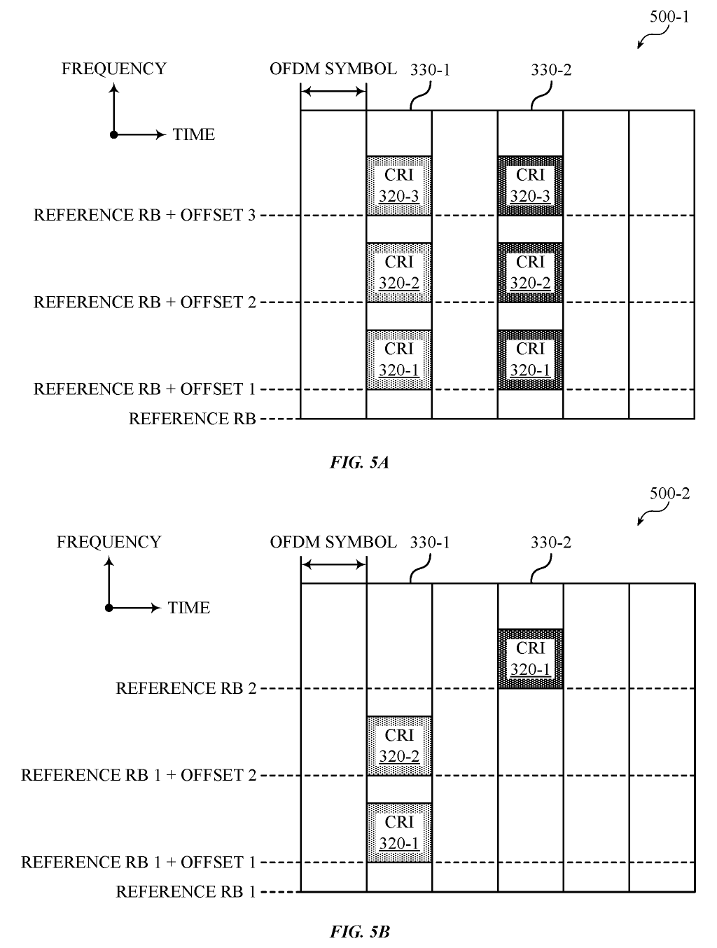

FIGS. 5A and 5B are diagrams of example CSI-RS resource configurations 500 for defining CSI-RS resources according to one or more implementations described herein. CSI-RS resource configurations 500 (e.g., CSI-RS resource configuration 500-1, CSI-RS resource configuration 500-2) can be implemented by a network, including one or more network devices, which can be examples of UE 210 and base station 222. CSI-RS resource configurations 500 each include axes associated with the time domain and the frequency domain. CSI-RS resource configurations 500 each include a quantity of OFDM symbols 330 (e.g., OFDM symbol 330-1, OFDM symbol 330-2) within the time domain. Likewise, each CSI-RS resource can be represented by a respective CRI 320.

Each CSI-RS resource configuration 500 can support multiple CSI-RS resources being mapped to a same OFDM symbol 330, as described with reference to FIGS. 4A and 4B. For example, each CSI-RS resource configuration 500 can support mapping a subset or all of the CSI-RS resources of a CSI-RS resource set to a same OFDM symbol 330. Additionally, or alternatively, each CSI-RS resource configuration 500 can support mapping one or more remaining CSI-RS resources to a different OFDM symbol 330. Further, each CSI-RS resource configuration 500 can support mapping the CSI-RS resources of another CSI-RS resource set to another same OFDM symbol 330.

CRIs 320 illustrated in each CSI-RS resource configuration 500 can be associated with a same or different CSI-RS resource set. That is, the CSI-RS resources associated with OFDM symbol 330-1 can be part of a same CSI-RS resource set as the CSI-RS resources associated with OFDM symbol 330-2. For example, in CSI-RS resource configuration 500-1, the CSI-RS resources associated with CRI 320-1, 320-2, and 320-3 that are mapped to OFDM symbol 330-1, and the CSI-RS resources associated with CRI 320-1, 320-2, and 320-3 that are mapped to OFDM symbol 330-2 can be associated with the same CSI-RS resource set. Alternatively, the CSI-RS resources mapped to OFDM symbol 330-1 can be part of a different CSI-RS resource set than the CSI-RS resources mapped to OFDM symbol 330-2. For example, in CSI-RS resource configuration 500-1, the CSI-RS resources associated with CRI 320-1, 320-2, and 320-3 that are mapped to OFDM symbol 330-1 can be associated with a CSI-RS resource set, and the CSI-RS resources associated with CRI 320-1, 320-2, and 320-3 that are mapped to OFDM symbol 330-2 can be associated with another CSI-RS resource set.

The CSI-RS resources of each CSI-RS resource configuration 500 can be associated with different frequencies for a same OFDM symbol 330 or across different OFDM symbols 330. That is, each CSI-RS resource can be associated with a respective frequency range. In some cases, each CSI-RS resource can be associated with a respective RB. For example, each CSI-RS resource can be communicated over the frequency range associated with a respective RB. Further, each CSI-RS resource can be offset within the frequency domain.

CSI-RS resource configuration 500-1 illustrates using a reference RB to define the CSI-RS resources. The reference RB can be associated with a location, which can refer to a frequency or frequency range, such as one or more sub-carriers or one or more sub-bands within the frequency domain. CSI-RS resource configuration 500-1 supports offsets which can be applied to the location of the reference RB. The offsets can refer to frequency offsets, which can be applied to the frequency or frequency range (e.g., a boundary of the frequency range) associated with the reference RB location.

In some examples, the same reference RB location can be configured for each CSI-RS resource of a CSI-RS resource set, and different offsets can be applied to the reference RB location for different CSI-RS resources of the CSI-RS resource set. For example, multiple CSI-RS resources (e.g., a subset or all CSI-RS resources) of a CSI-RS resource set can be associated with a same OFDM symbol 330, and each CSI-RS resource can be associated with a different offset. In some such examples, CSI-RS resources mapped to different OFDM symbols 330 can use a same offset. For example, the CSI-RS resource corresponding to CRI 320-1 associated with OFDM symbol 330-2 can use a same offset as the CSI-RS resource corresponding to CRI 320-2 associated with OFDM symbol 330-1, where the CSI-RS resources corresponding to CRI 320-1 and CRI 320-2 are part of a same CSI-RS resource set.

In some examples, the same reference RB location can be configured for each CSI-RS resource of multiple CSI-RS resource sets, and different offsets can be applied to the reference RB location for different CSI-RS resources of the CSI-RS resource sets. In some such cases, CSI-RS resources of different CSI-RS resource sets can use similar offsets based on the CSI-RS resources being mapped to different OFDM symbols 330. For example, the CSI-RS resource corresponding to CRI 320-1 associated with OFDM symbol 330-2 can use a same offset as the CSI-RS resource corresponding to CRI 320-2 associated with OFDM symbol 330-1. In some such examples, the CSI-RS resources corresponding to CRI 320-1 and CRI 320-2 are associated with different CSI-RS resource sets.

The CSI-RS resource configuration 500-1 can support a quantity of offsets, where each offset can define a respective CSI-RS resource within the frequency domain. For example, the CSI-RS resource associated with CRI 320-1 (e.g., at OFDM 330-1, at OFDM 330-2) can be defined by a first offset (e.g., offset 1) applied to the reference RB location (e.g., reference RB + offset 1). Likewise, the CSI-RS resource associated with CRI 320-2 (e.g., at OFDM 330-1, at OFDM 330-2) can be defined by a second offset (e.g., offset 2) applied to the reference RB location (e.g., reference RB + offset 2). Further, the CSI-RS resource associated with CRI 320-3 (e.g., at OFDM 330-1, at OFDM 330-2) can be defined by a third offset (e.g., offset 3) applied to the reference RB location (e.g., reference RB + offset 3). In some examples, the third offset can be greater than the second offset, and the second offset can be greater than the first offset.

CSI-RS resource configuration 500-2 illustrates using multiple reference RBs to define the CSI-RS resources. Each reference RB can be associated with a respective location. CSI-RS resource configuration 500-2 supports offsets which can be applied to the respective locations of the reference RBs. In some examples, the CSI-RS resources can be defined by a respective reference RB location and not based on offsets applied to the reference RB location.

In some examples, different reference RB locations can be configured for CSI-RS resources of a CSI-RS resource set. That is, different reference RB locations can be configured for CSI-RS resources associated with different OFDM symbols 330. For example, a first reference RB (e.g., RB 1) location can be configured for the CSI-RS resources (e.g., CRI 320-1, CRI 320-2) mapped to OFDM symbol 330-1, and a second reference RB (e.g., RB 2) location can be configured for the CSI-RS resources (e.g., CRI 320-1) mapped to OFDM symbol 330-2. In some such examples, the CSI-RS resources mapped to OFDM symbol 330-1 and the CSI-RS resources mapped to OFDM symbol 330-2 can be associated with the same CSI-RS resource set. In some examples, different reference RB locations can be configured for CSI-RS resources associated with the same OFDM symbol 330.

In some examples, different reference RB locations can be configured for different CSI-RS resource sets. For example, CSI-RS resources (e.g., CRI 320-1 and CRI 320-2 mapped to OFDM symbol 330-1) of a first CSI-RS resource set can be defined relative to the first reference RB location, and CSI-RS resources (e.g., CRI 320-1 mapped to OFDM symbol 330-1) of a second CSI-RS resource set can be defined relative to the second RB location. In some examples, each CSI-RS resource set can be defined by multiple reference RB locations.

The CSI-RS resource configuration 500-2 can support a quantity of offsets which can be applied to the respective reference RB locations, where each offset can define a respective CSI-RS resource within the frequency domain. For example, the CSI-RS resource associated with CRI 320-1 (e.g., at OFDM 330-1) can be defined by a first offset (e.g., offset 1) applied to the first reference RB location (e.g., reference RB 1 + offset 1). Likewise, the CSI-RS resource associated with CRI 320-2 (e.g., at OFDM 330-1) can be defined by a second offset (e.g., offset 2) applied to the first reference RB location (e.g., reference RB 1 + offset 2). Further, the CSI-RS resource associated with CRI 320-1 (e.g., at OFDM 330-2) can be defined by the second reference RB location (e.g., reference RB 2).

Although the CSI-RS resource associated with CRI 320-1 at OFDM 330-2 is illustrated without an offset applied to the second reference RB location, it should be understood that an offset could be applied to the second reference RB location to define the CSI-RS resource. In some examples, the CSI-RS resources associated with CRI 320-1 and CRI 320-2 at OFDM 330-1, and the CSI-RS resource associated with CRI 320-1 at OFDM 330-2 can be part of the same CSI-RS resource set. In other examples, the CSI-RS resources associated with CRI 320-1 and CRI 320-2 mapped to OFDM 330-1 can be associated with a first CSI-RS resource set, and the CSI-RS resource associated with CRI 320-1 mapped to OFDM 330-2 can be associated with a second CSI-RS resource set.

In some examples, for both CSI-RS resource configuration 500-1 and 500-2, the offsets applied to the reference RB location (e.g., or multiple reference RB locations), can be configured. In some implementations, the offsets can be equivalently spaced along the frequency domain, such that equivalently spaced offsets can be applied to the CSI-RS resources. In some such implementations, the offsets can be configured based on multiplying the offsets by a factor corresponding to the respective CSI-RS resource ID of the CSI-RS resource (e.g., within a CSI-RS resource set). For example, the offsets can correspond to frequency magnitudes, such that each CSI-RS resource can be separated by a frequency range based on the frequency magnitude. In other examples, the offsets can correspond to sequential frequency ranges, such that the CSI-RS resources can be associated with adjacent frequency ranges.

In other implementations, separate, independent offsets can be configured. That is, the offsets can be configured for respective CSI-RS resources, such that respective offsets can be applied to each CSI-RS resource. The independent offsets can be applied to the one or more reference RB locations to result in non-overlapping CSI-RS resources along the frequency domain. That is, the offsets can result in non-overlapping sub-bands within a BWP, each of which configured for a respective CSI-RS resource. For example, the first offset (e.g., offset 1) can be associated with a different magnitude than the second offset (e.g., offset 2).

For both CSI-RS resource configuration 500-1 and 500-2, a network can be configured to support the respective CSI-RS resource settings. For example, a base station can be configured to transmit to a UE, one or more CSI-RSs using the CSI-RS resources, in accordance with CSI-RS resource configuration 500-1 or CSI-RS resource configuration 500-2. That is, the base station can transmit multiple CSI-RSs (e.g., or multiple portions of a CSI-RS) during a same OFDM symbol using different frequencies defined relative to a reference RB location (e.g., in accordance with CSI-RS resource configuration 500-1) for each CSI-RS resource. Alternatively, the base station can transmit multiple CSI-RSs (e.g., or multiple portions of a CSI-RS) resources across OFDM symbols using different frequencies defined relative to different reference RB locations for each OFDM symbol (e.g., in accordance with CSI-RS resource configuration 500-2). The network can support applying offsets (e.g., equivalently spaced offsets, or independent offsets) to the one or more reference RB locations.

In some implementations, the base station can transmit indications of the CSI-RS resources in accordance with CSI-RS resource configuration 500-1 or CSI-RS resource configuration 500-2. After receiving the CSI-RSs, or the indications of the CSI-RS resources for receiving the CSI-RSs, the UE can perform CSI measurement using the CSI-RS to determine CSI. For example, UE 210 can perform RSRP and/or SINR measurement (e.g., L1-RSRP measurement and L1-SINR measurement). Then, the UE can support CSI reporting to the base station, which the base station can use for beam selection, among other operations.

In accordance with examples as described herein, CSI-RS resource configurations 500 can support multiple CSI-RS resources of a CSI-RS resource set being associated with different frequencies based on one or more reference RB locations. Supporting multiple CSI-RS resources mapped to the same OFDM symbol 330 can provide reduced latency for a network based on utilizing concurrent signaling, thereby improving performance, among other advantages.

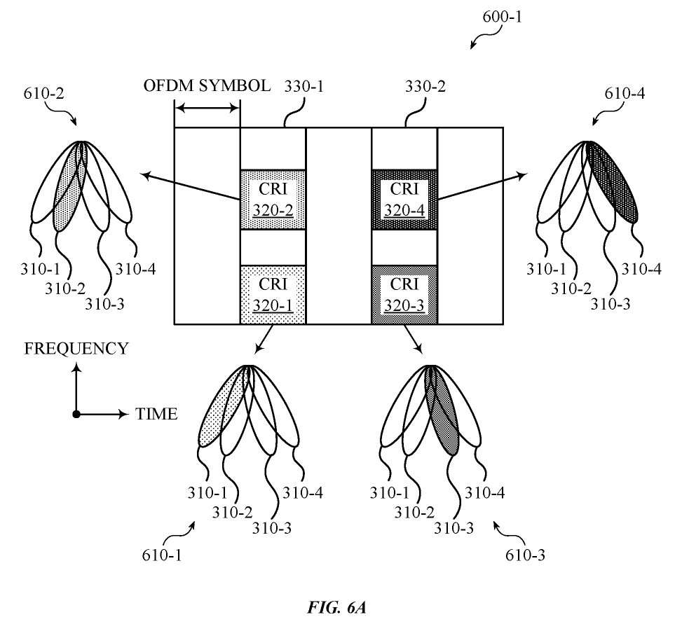

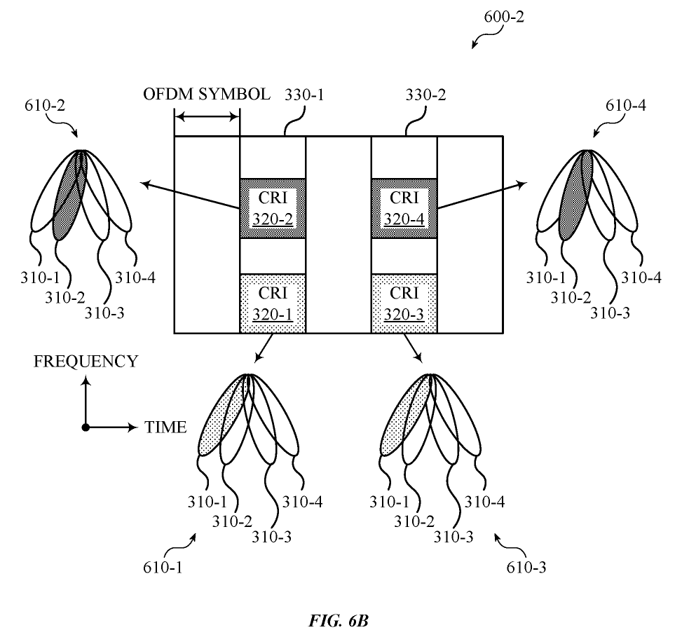

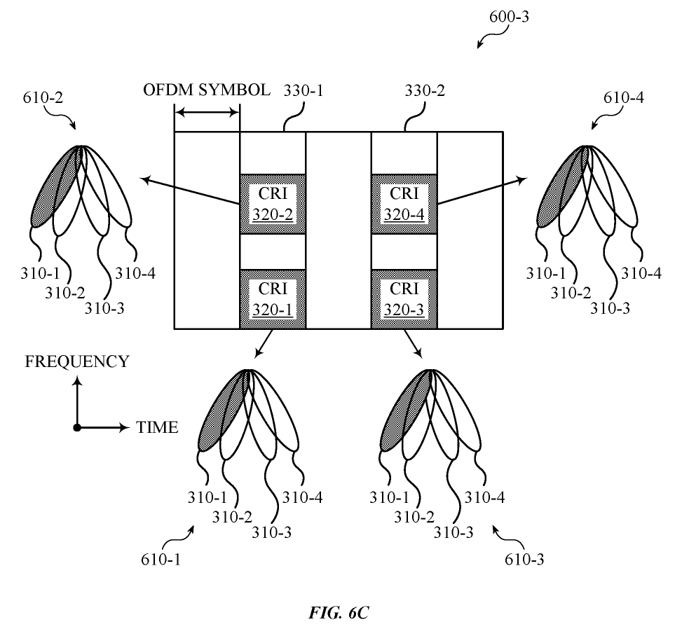

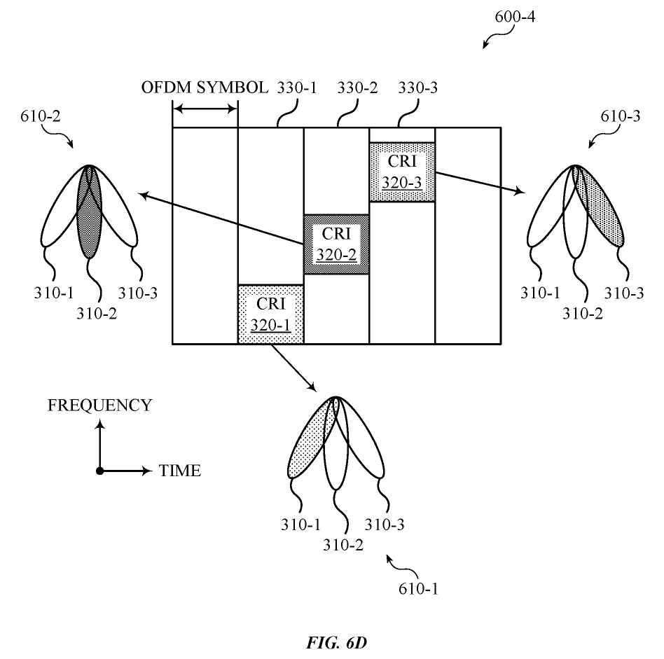

FIGS. 6A, 6B, 6C, and 6D are diagrams of example beam configurations 600 associated with CSI-RS resources according to one or more implementations described herein. Beam configurations 600 (e.g., beam configuration 600-1, beam configuration 600-2, beam configuration 600-3, beam configuration 600-4) can be implemented by a network, including one or more network devices, which can be examples of UE 210 and base station 222. Beam configurations 600 illustrate example CSI-RS resource configurations associated with each beam configuration 600, which can be examples of CSI-RS resource configuration 400-1, CSI-RS resource configuration 400-2, CSI-RS resource configuration 500-1, or CSI-RS resource configuration 500-2. The CSI-RS resource configurations can each include axes associated with the time domain and the frequency domain, as well as a quantity of OFDM symbols 330 (e.g., OFDM symbol 330-1, OFDM symbol 330-2, OFDM symbol 330-3) within the time domain.

Beam configurations 600 each illustrate CRIs 320, which can be representative of a respective CSI-RS resource. In some examples, each CSI-RS resource of a respective beam configuration 600 can be associated with a same CSI-RS resource set. For example, the CSI-RS resources corresponding to CRI 320-1, CRI 320-2, CRI 320-3, and CRI 320-4 can be part of the same CSI-RS resource set. In other examples, the CSI-RS resources of a respective beam configuration 600 can be associated with different CSI-RS resource sets. For example, the CSI-RS resources corresponding to CRI 320-1 and CRI 320-2 can be part of the same CSI-RS resource set, and the CSI-RS resources corresponding to CRI 320-3 and CRI 320-4 can be part of another same CSI-RS resource set. In some examples, each CSI-RS resource set can be associated with a CSI-RS. In other examples, each CSI-RS resource can be associated with a respective CSI-RS.

Each beam configuration 600 can support transmitting a CSI-RS (e.g., or multiple CSI-RSs) using multiple CSI-RS resources mapped to a same OFDM symbol 330, as described with reference to FIGS. 4A and 4B. For example, each beam configuration 600 can support a subset or all of the CSI-RS resources of a CSI-RS resource set being mapped to a same OFDM symbol 330. Additionally, or alternatively, each beam configuration 600 can support one or more remaining CSI-RS resources being mapped to a different OFDM symbol 330. Further, each beam configuration 600 can support the CSI-RS resources of another CSI-RS resource set being mapped to another same OFDM symbol 330.

Each beam configuration 600 can also support CSI-RS resources at different frequencies for a same OFDM symbol 330, as described with reference to FIGS. 5A and 5B. For example, each beam configuration 600 can support one or more CSI-RS resource sets being defined relative to a reference RB location in the frequency domain. Additionally, or alternatively, each beam configuration 600 can support CSI-RS resources of each CSI-RS resource set being defined by multiple reference RB locations based on OFDM symbol 330 associated with the respective CSI-RS resource. Further, beam configurations 600 can support applying offsets to the one or more reference RB locations to define the CSI-RS resources within the frequency domain, in which the offsets are independent configured or equivalently spaced for each CSI-RS resource.

Each beam configuration 600 can include a quantity of beam arrangements 610 (e.g., beam arrangement 610-1, beam arrangement 610-2, beam arrangement 610-3, beam arrangement 610-4). Each beam arrangement 610 includes a quantity of potential beams 310 which a base station (e.g., base station 222) can be configured to use for communicating signaling (e.g., one or more CSI-RSs, one or more portions of a single CSI-RS). Each beam arrangement 610 also includes a selected beam 310 which can be associated with a respective CSI-RS resource. That is, each beam arrangement 610 illustrates one beam 310 of the quantity of potential beams 310 which can be selected for transmitting a portion of a CSI-RS using the CSI-RS resource corresponding to the CRI 320 associated with the respective beam arrangement. For example, beam arrangement 610-1 of beam configuration 600-1 illustrates beam 310-1 being associated with the CSI-RS resource corresponding to CRI 320-1. Although each beam arrangement 610 illustrates a quantity of potential beams 310 (e.g., 3 beams, 4 beams), each beam configuration 600 can support a different quantity of potential beams 310 for the respective beam arrangements 610.

Beam configuration 600-1 illustrates each CSI-RS resource being associated with a different beam 310 of the potential beams 310. That is, different beams 310 can be used to in accordance with CSI-RS resources mapped to a same OFDM symbol 330. Additionally, different beams 310 can be associated with CSI-RS resources across different OFDM symbols 330. In some examples, using different beams within a same OFDM symbol 330 and across different OFDM symbols can be associated with repetition parameters (e.g., a time repetition parameter and a frequency repetition parameter) being set to “OFF” for the time domain and the frequency domain. That is, a beam 310 used for transmission may not be repeated in the time domain (e.g., a P2 type operation), such that a same beam 310 may not be implemented for transmitting using CSI-RS resources (e.g., for a same frequency) at different OFDM symbols 330. Likewise, a beam 310 used for transmission may not be repeated in the frequency domain (e.g., a P2 type operation), such that a same beam 310 may not be implemented for transmitting using CSI-RS resources at different frequencies (e.g., one or more sub-carriers, one or more sub-bands) for a same OFDM symbol 330.

Beam configuration 600-1 illustrates transmitting with a different beam 310 within the respective beam arrangements 610. For example, to transmit using the CSI-RS resource associated with CRI 320-1, beam arrangement 610-1 can be implemented, in which beam 310-1 is selected from the potential beams 310. Likewise, to transmit using the CSI-RS resource associated with CRI 320-2, beam arrangement 610-2 can be implemented, in which beam 310-2 is selected from the potential beams 310. Additionally, or alternatively, to transmit using the CSI-RS resource associated with CRI 320-3, beam arrangement 610-3 can be implemented, in which beam 310-3 is selected from the potential beams 310. Further, to transmit using the CSI-RS resource associated with CRI 320-4, beam arrangement 610-4 can be implemented, in which beam 310-4 is selected from the potential beams 310.

Implementing beam configuration 600-1 can support transmission beam sweeping. That is, the beams 310 of beam configuration 600-1 can be examples of transmission beams which can be transmitted from a base station (e.g., base station 222) to a UE (e.g., UE 210). In some examples, the UE receiving the CSI-RS can use a same reception beam. The base station can use different beams 310 for transmitting the CSI-RS resources, and because the UE uses a same reception beam, the beam 310 (e.g., transmission beam) with the relatively highest signal strength or quality can be selected (e.g., for use in future operations). In some examples, beam sweeping can include the UE performing CSI measurement for each beam 310 and indicating to the base station which beam 310 is associated with the relatively highest signal strength. In some implementations, beam configuration 600-1 can support relatively low latency for performing beam sweeping and transmission beam selection.

Beam configuration 600-2 illustrates each CSI-RS resource being associated with a different beam 310 for an OFDM symbol 330 (e.g., a same OFDM symbol 330). That is, CSI-RS resources mapped to a same OFDM symbol 330 (e.g., and different frequencies) can be associated with different beams 310. However, CSI-RS resources mapped to different OFDM symbols 330, and similar frequencies (e.g., same frequency ranges), can be transmitted using the same beam 310.

In some examples, using different beams for CSI-RS resources mapped to a same OFDM symbol 330, but using the same beams for CSI-RS resources across different OFDM symbols (e.g., for CSI-RS resources associated with the same frequencies) can be associated with a repetition parameter (e.g., the time repetition parameter) being set to “ON” for the time domain and a repetition parameter (e.g., the frequency repetition parameter) being set to “OFF” for the frequency domain.

That is, a beam 310 used for transmission can be repeated in the time domain (e.g., a P3 type operation), such that a same beam 310 can be implement for transmitting using CSI-RS resources (e.g., associated with a same frequency) at different OFDM symbols 330. Likewise, a beam 310 used for transmission may not be repeated in the frequency domain (e.g., a P2 type operation), such that a same beam 310 may not be implemented for transmitting using CSI-RS resources at different frequencies (e.g., one or more sub-carriers, one or more sub-bands) for a same OFDM symbol 330.

Beam configuration 600-2 illustrates repeating the beams 310 in the time domain, such that similar beam arrangements 610 are implemented for different OFDM symbols 330. For example, to transmit using the CSI-RS resource associated with CRI 320-1, beam arrangement 610-1 can be implemented, in which beam 310-1 is selected from the potential beams 310. Likewise, to transmit using the CSI-RS resource associated with CRI 320-3, beam arrangement 610-3 can be implemented, in which beam 310-1 is selected from the potential beams 310. Whereas, to transmit using the CSI-RS resource associated with CRI 320-2, beam arrangement 610-2 can be implemented, in which beam 310-2 is selected from the potential beams 310. Similarly, to transmit using the CSI-RS resource associated with CRI 320-4, beam arrangement 610-4 can be implemented, in which beam 310-2 is selected from the potential beams 310. That is, the CSI-RS resources corresponding to CRI 320-1 and CRI 320-3 can be associated with the same beam 310-1, and the CSI-RS resources corresponding to CRI 320-2 and CRI 320-4 can be associated with another same beam 310-2.

Implementing beam configuration 600-2 can support modified beam sweeping. That is, the UE receiving the beams 310 can use a same reception beam for each CSI-RS resource mapped to a same OFDM symbol 330 (e.g., CRI 320-1 and CRI 320-2, or CRI 320-3 and CRI 320-4). However, the UE can use a different reception beam for CSI-RS resources mapped to different OFDM symbols 330 (e.g., CRI 320-1 and CRI 320-3, or CRI 320-2 and CRI 320-4). Because beam configuration 600-2 includes using multiple transmission beams 310 and multiple reception beams, beam configuration 600-2 can support relatively low latency for performing beam sweeping and beam selection for both transmission beams 310 and reception beams.

Beam configuration 600-3 illustrates each CSI-RS resource being associated with a same beam 310 of the potential beams 310. That is, the same selected beam 310 can be used for CSI-RS resources mapped to a same OFDM symbol 330 and across different OFDM symbols 330. In some examples, using the same beam 310 within a same OFDM symbol 330 and across different OFDM symbols can be associated with repetition parameters (e.g., the time repetition parameter and the frequency repetition parameter) being set to “ON” for the time domain and the frequency domain. That is, a beam 310 used for transmission can be repeated in the time domain (e.g., a P3 type operation), such that a same beam 310 can be implemented for transmitting using CSI-RS resources (e.g., for a same frequency) mapped to different OFDM symbols 330. Likewise, a beam 310 used for transmission can be repeated in the frequency domain (e.g., a P3 type operation), such that a same beam 310 can be implemented for transmitting using CSI-RS resources at different frequencies (e.g., one or more sub-carriers, one or more sub-bands) mapped to a same OFDM symbol 330.

Beam configuration 600-3 illustrates transmitting each CSI-RS with a same beam 310 within the respective beam arrangements 610. For example, to transmit using the CSI-RS resource associated with CRI 320-1, beam arrangement 610-1 can be implemented, in which beam 310-1 is selected from the potential beams 310. Likewise, to transmit using the CSI-RS resource associated with CRI 320-2, beam arrangement 610-2 can be implemented, in which beam 310-1 is selected from the potential beams 310. Additionally, or alternatively, to transmit using the CSI-RS resource associated with CRI 320-3, beam arrangement 610-3 can be implemented, in which beam 310-1 is selected from the potential beams 310. Further, to transmit using the CSI-RS resource associated with CRI 320-4, beam arrangement 610-4 can be implemented, in which beam 310-1 is selected from the potential beams 310.

Implementing beam configuration 600-3 can support reception beam sweeping. In some examples, the UE receiving the CSI-RS can use a different reception beam associated with each CSI-RS resource. The base station can use the same beam 310 for transmitting the CSI-RS, and because the UE uses different reception beams for the CSI-RS resources, the reception beam with the relatively highest signal strength or quality can be selected (e.g., for use in future operations). In some examples, beam sweeping can include the UE performing CSI measurement for each reception beam. In some implementations, the UE can indicate to the base station which reception beam is associated with the relatively highest signal strength. In some implementations, beam configuration 600-3 can support relatively low latency for performing beam sweeping and reception beam selection.

Beam configuration 600-4 illustrates each CSI-RS resource being associated with a different beam 310, where each CSI-RS resource is associated with a different frequency (e.g., sub-band) across the OFDM symbols 310. That is, beam configuration 600-4 illustrates a CSI-RS resource configuration in which each CSI-RS resource is mapped to a different OFDM symbol 330. Additionally, each CSI-RS resource is associated with a different frequency range, despite each CSI-RS being mapped to a different OFDM symbol 330. In some examples, using different beams across different OFDM symbols can be associated with repetition parameters (e.g., the time repetition parameter and the frequency repetition parameter) being set to “OFF” for the time domain and the frequency domain. That is, a beam 310 used for transmission may not be repeated in the time domain (e.g., a P2 type operation), such that a same beam 310 may not be implemented for transmitting using CSI-RS resources mapped to different OFDM symbols 330. Likewise, a beam 310 used for transmission may not be repeated in the frequency domain (e.g., a P2 type operation), such that a same beam 310 may not be implemented for transmitting using CSI-RS resources at different frequencies.

Beam configuration 600-4 illustrates transmitting each CSI-RS with a different beam 310 within the respective beam arrangements 610. For example, to transmit using the CSI-RS resource associated with CRI 320-1 at OFDM symbol 330-1, beam arrangement 610-1 can be implemented, in which beam 310-1 is selected. Likewise, to transmit using the CSI-RS resource associated with CRI 320-2 at OFDM symbol 330-2, beam arrangement 610-2 can be implemented, in which beam 310-2 is selected. Additionally, or alternatively, to transmit using the CSI-RS resource associated with CRI 320-3 at OFDM symbol 330-3, beam arrangement 610-3 can be implemented, in which beam 310-3 is selected.

Implementing beam configuration 600-4 can support transmission beam sweeping. In some examples, the UE receiving the CSI-RS can use a same reception beam. The base station can use different beams 310 for transmitting using the CSI-RS resources, and because the UE uses a same reception beam for the CSI-RS resources, the beam 310 (e.g., transmission beam) with the relatively highest signal strength or quality can be selected (e.g., for use in future operations). In some examples, beam sweeping can include the UE performing CSI measurement for each beam 310 and indicating to the base station which beam 310 is associated with the relatively highest signal strength. In some implementations, beam configuration 600-4 can support determining a sub-band specific analog beam for the UE, in which the UE is not capable of frequency selective reception beamforming. For example, beam configuration 600-4 can provide solutions directed to beam squinting or near field disadvantages that can be otherwise associated with a UE incapable of frequency selective beamforming.

For each beam configuration 600, a network can be configured to support the respective beam arrangements 610. For example, a base station (e.g., base station 222) can be configured to transmit one or more CSI-RSs to a UE (e.g., UE 210), in accordance with beam arrangements 610 of beam configuration 600-1, beam configuration 600-2, beam configuration 600-3, and/or beam configuration 600-4. That is, the base station can transmit using beams 310 that are repeated in the time domain and/or the frequency domain. Additionally, or alternatively, the base station can transmit CSI-RS resources via beams 310 that are not repeated in the time domain and/or the frequency domain. In some examples, the base station can support transmitting indications of the CSI-RS resources, which can be used to receive the one or more CSI-RSs at the UE. In some such examples, the indications of the CSI-RS resources can be transmitted in accordance with the beam arrangements 610 as described herein.

In accordance with examples as described herein, beam configurations 600 can support RSRP and/or SINR measurement (e.g., L1-RSRP measurement and L1-SINR measurement) at the UE based on receiving the one or more CSI-RSs. Additionally, beam configurations 600 support beam sweeping and selection for the base station and/or the UE, as well as provide reduced latency for a network (e.g., based on utilizing concurrent signaling or low latency beam sweeping), thereby improving performance, among other advantages.

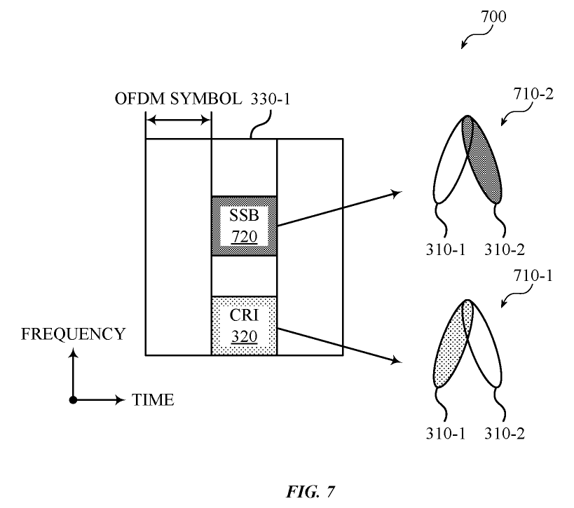

FIG. 7 is a diagram of an example combined configuration 700 for mapping CSI-RS resources and SSB resources to a same OFDM symbol according to one or more implementations described herein. Combined configuration 700 can be implemented by a network, including one or more network devices, which can be examples of UE 210 and base station 222. Combined configuration 700 illustrates a resource configuration and associated beam arrangements 710. The resource configuration includes an axes associated with the time domain and the frequency domain, as well as a quantity of OFDM symbols 330 (e.g., OFDM symbol 330-1) within the time domain.

Combined configuration 700 illustrates a resource configuration including CRI 320, which can be representative of a CSI-RS resource. Additionally, combined configuration 700 illustrates an SSB resource 720, which can be include time and frequency resources associated with a synchronization signal. The CSI-RS resource corresponding to CRI 320 can be associated with (e.g., a part of) a CSI-RS resource set, and SSB resource 720 can be associated with (e.g., a part of) an SSB (e.g., a set of SSB resources). Although combined configuration 700 illustrates a single CSI-RS resource and a single SSB resource 720, combined configuration 700 can support a different quantity of CSI-RS resources and SSB resources.

Combined configuration 700 illustrates mapping CSI-RS resources and SSB resources to a same OFDM symbol 330. That is, SSB resource 720 and the CSI-RS resource corresponding to CRI 320 can be used for transmission at OFDM symbol 330-1. Additionally, SSB resource 720 and the CSI-RS resource corresponding to CRI 320 can be associated with different frequencies. For example, SSB resource 720 and the CSI-RS resource corresponding to CRI 320 can associated with non-overlapping frequencies, such as different frequency ranges. In some such examples, to transmit using SSB resource 720 and the CSI-RS resource corresponding to CRI 320 at non-overlapping frequencies, combined configuration 700 can support techniques described with reference to CSI-RS resource configurations 500. For example, SSB resource 720 and the CSI-RS resource corresponding to CRI 320 can be defined relative to one or more reference RB locations in the frequency domain, or one or more offsets (e.g., frequency offsets) applied to the one or more reference RB locations.

Combined configuration 700 can include a quantity of beam arrangements 710 (e.g., beam arrangement 710-1, beam arrangement 710-2). Each beam arrangement 710 includes a quantity of potential beams 310 which a base station (e.g., base station 222) can be configured to use for communicating signaling (e.g., one or more CSI-RSs, one or more SSBs). Each beam arrangement 710 also includes a selected beam 310 which can be used to transmit in accordance with a respective resource (e.g., the CSI-RS resource, SSB resource 720). For example, beam arrangement 710-1 illustrates beam 310-1 being selected for transmitting one or more portions of a CSI-RS using the CSI-RS resource corresponding to CRI 320. Likewise, beam arrangement 710 illustrates beam 310-2 being selected for transmitting an SSB using SSB resource 720. Although each beam arrangement 710 illustrates a quantity of potential beams 310 (e.g., 2 beams), combined configuration 700 can support a different quantity of potential beams 310 for the respective beam arrangements 710.

Combined configuration 700 illustrates using different beams 310 being associated with the CSI-RS resources and the SSB resources. That is, the CSI-RS resource corresponding to CRI 320 can be associated with beam 310-1 of the potential beams 310, and SSB resource 720 can be associated with beam 310-2 of the potential beams 310. In some examples, different beams 310 can be used for transmitting different types of signaling. Thus, transmitting the one or more portions of the CSI-RS and the SSB with different beams 310 can be based on the CSI-RS resource and SSB resource 720 being different types of resources. In some implementations, different beams 310 can be used for transmitting using different frequencies. Thus, transmitting the one or more portions of the CSI-RS and the SSB with different beams can be based on the CSI-RS resource and SSB resource 720 being associated with different frequencies. In some instances, different beams 310 can be used for transmitting during a same OFDM symbol 330. Thus, transmitting the one or more portions of the CSI-RS and the SSB with different beams 310 can be based on the CSI-RS resource and SSB resource 720 being mapped to OFDM symbol 330-1.

A network can be configured to support the respective beam arrangements 710 of combined configuration 700. For example, a base station (e.g., base station 222) can be configured to transmit using the CSI-RS resources and using SSB resources to a UE (e.g., UE 210), in accordance with combined configuration 700. That is, the base station can transmit one or more portions of the CSI-RS and the SSB during a same OFDM symbol 330 and with non-overlapping frequency resources, using different beams. In accordance with examples as described herein, combined configuration 700 can support RSRP and/or SINR measurement (e.g., L1-RSRP measurement and L1-SINR measurement) at the UE based on receiving the one or more portions of the CSI-RS and/or the SSB. Additionally, combined configuration 700 can support reduced latency for a network (e.g., based on utilizing concurrent signaling for different resources), thereby improving performance, among other advantages.

In some examples, a UE (e.g., UE 210) may not be configured (e.g., traditionally) to support different beams (e.g., transmission beams, reception beams) being associated with a same OFDM symbol 330. That is, the UE may not support frequency selective beamforming. However, implementing the configurations described herein, including CSI-RS resource configurations 400, CSI-RS resource configurations 500, beam configurations 600, and/or combined configuration 700 can enable the UE to support aspects of frequency selective beamforming. Thus, implementing the techniques described herein can enable a UE to support different beams using different resources being communicated at a same OFDM symbol 330.

In other examples, the UE can be configured to support frequency selective beamforming. That is, the UE can be configured to support different beams being associated with a same OFDM symbol 330, based on a network associated with the UE being configured in accordance with the techniques described herein. That is, the UE can be configured to support frequency selective beamforming based on the configuration described in CSI-RS resource configurations 400, CSI-RS resource configurations 500, beam configurations 600, and/or combined configuration 700.

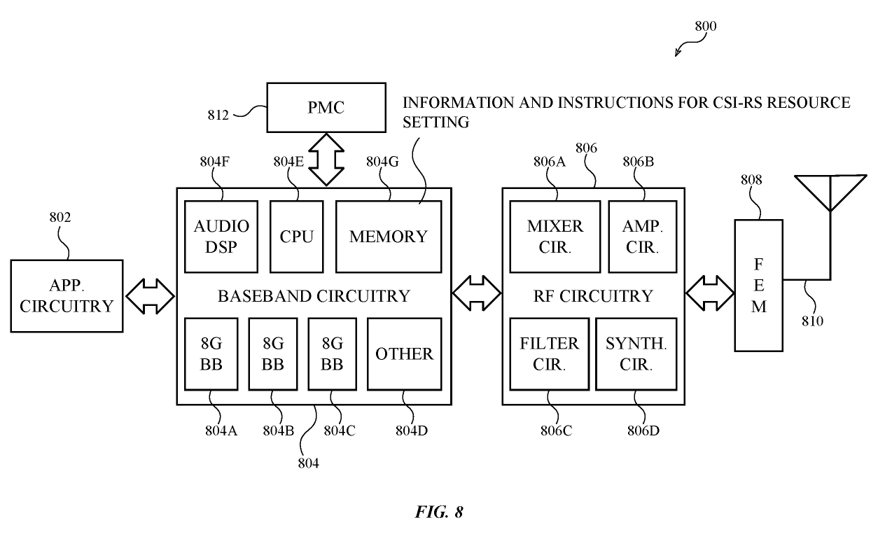

FIG. 8 is a diagram of an example of components of a device configured to support CSI-RS resource setting according to one or more implementations described herein. In some implementations, device 800 can include application circuitry 802, baseband circuitry 804, RF circuitry 806, front-end module (FEM) circuitry 808, one or more antennas 810, and power management circuitry (PMC) 812 coupled together at least as shown. In some implementations, device 800 can include fewer elements (e.g., a RAN node may not utilize application circuitry 802 and can instead include a processor/controller to process data received from a core network. In some implementations, device 800 can include additional elements such as, for example, memory/storage, display, camera, ‎sensor (including one or more temperature sensors, such as a single temperature sensor, a plurality of temperature sensors at different locations in device 800, etc.), or input/output (I/O) interface.‎ In other implementations, the components described below can be included in more than one device (e.g., said circuitries can be separately included in more than one device for cloud-RAN (C-RAN) implementations).

Application circuitry 802 can include one or more application processors. For example, application circuitry 802 can include circuitry such as, but not limited to, one ‎or more single-core or multi-core processors. ‎The processor(s) can include any combination of ‎general-purpose processors and ‎dedicated processors (e.g., graphics processors, application ‎processors, etc.). The processors can be coupled with or can include memory/storage and can be configured to ‎execute instructions stored in the memory/storage to enable various applications or ‎operating systems to run on device 800. In some implementations, processors of application circuitry 802 can process data packets received from a core network.

Baseband circuitry 804 can include circuitry such as, but not limited to, one ‎or more single-core or multi-core processors. Baseband circuitry 804 can include one or more baseband ‎processors or control logic to process baseband signals received from a receive signal path of RF circuitry 806 and to generate baseband signals for a transmit signal path of RF circuitry 806. Baseband circuity 804 can interface with application circuitry 802 for generation and processing of the baseband signals and for controlling operations of RF circuitry 806. For example, in some implementations, baseband circuitry 804 can include a 3G baseband processor 804A, a 4G baseband processor 804B, a 5G baseband processor 804C, or other baseband processor(s) 804D for other existing generations, generations in development or to be developed in the future (e.g., 5G, 6G, 8G, etc.).

Baseband circuitry 804 (e.g., one or more of baseband processors 804A-804D) can handle various radio control functions that enable ‎communication with one or more radio networks via RF circuitry 806. In other implementations, some or all of the functionality of baseband processors 804A-804D can be included in modules stored in memory 804G and executed via a central processing unit (CPU) 804E. The radio control functions ‎can include, but are not limited to, signal modulation/demodulation, encoding/decoding, radio frequency ‎shifting, etc. In some implementations, modulation/demodulation circuitry of baseband circuitry 804 can include Fast-Fourier Transform (FFT), precoding, or constellation mapping/de-mapping functionality. In some implementations, encoding/decoding circuitry of baseband circuitry 804 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 804G can receive and/or store information and instructions for CSI-RS resource setting as described herein. The information and instructions can support frequency selective beamforming directed to CSI-RS resources. For example, the techniques described herein support communicating, between base station 222 and UE 210, one or more CSI-RSs in accordance with multiple CSI-RS resources mapped to a same OFDM symbol, based on using different frequencies. Likewise, different beams can be used for communicating during the same OFDM symbol, or across multiple OFDM symbols, which can support frequency selective beamforming techniques at base station 222 and UE 210. Many other aspects and examples are also described herein.

In some implementations, baseband circuitry 804 can include one or more audio digital signal processor(s) (DSP) 804F. Audio DSP 804F can include elements for compression/decompression and echo cancellation and can include other suitable processing elements in other implementations. Components of baseband circuitry 804 can be suitably combined in a single chip, a single chipset, or disposed on a same circuit board in some implementations. In some implementations, some or all of the constituent components of baseband ‎circuitry 804 and application circuitry 802 can be implemented ‎together such as, for example, on a system on a chip (SOC).

In some implementations, baseband circuitry 804 can provide for communication ‎compatible with one or more radio technologies. For example, in some implementations, ‎baseband circuitry 804 can support communication with a NG-RAN, an evolved universal terrestrial radio ‎access network (EUTRAN) or other wireless metropolitan area networks (WMAN), a ‎wireless local area network (WLAN), a wireless personal area network (WPAN), etc. Implementations in ‎which baseband circuitry 804 is configured to support radio communications of more than ‎one wireless protocol can be referred to as multi-mode baseband circuitry.

RF circuitry 806 can enable communication with wireless networks using ‎modulated ‎electromagnetic radiation through a non-solid medium. In various implementations, ‎RF circuitry 806 can include switches, filters, amplifiers, etc., to facilitate the communication ‎with the wireless network. RF circuitry 806 can include a receive signal path which can include circuitry to down-convert RF signals received from FEM circuitry 808 and provide baseband signals to baseband circuitry 804. RF circuitry 806 can also include a transmit signal path which can include circuitry to up-convert baseband signals provided by baseband circuitry 804 and provide RF output signals to FEM circuitry 808 for transmission.

In some implementations, the receive signal path of RF circuitry 806 can include mixer circuitry 806A, amplifier circuitry 806B and filter circuitry 806C. In some implementations, the transmit signal path of RF circuitry 806 can include filter circuitry 806C and mixer circuitry 806A. RF circuitry 806 can also include synthesizer circuitry 806D for synthesizing a frequency for use by mixer circuitry 806A of the receive signal path and the transmit signal path. In some implementations, mixer circuitry 806A of the receive signal path can be configured to down-convert RF signals received from FEM circuitry 808 based on the synthesized frequency provided by synthesizer circuitry 806D. Amplifier circuitry 806B can be configured to amplify the down-converted signals and filter circuitry 806C can be a low-pass filter (LPF) or band-pass filter (BPF) configured to remove unwanted signals from the down-converted signals to generate output baseband signals. Output baseband signals can be provided to baseband circuitry 804 for further processing. In some implementations, the output baseband signals can be zero-frequency baseband signals, although this may not be a requirement. In some implementations, mixer circuitry 806A of the receive signal path can comprise passive mixers, although the scope of the implementations is not limited in this respect.

In some implementations, mixer circuitry 806A of the transmit signal path can be configured to up-convert input baseband signals based on the synthesized frequency provided by synthesizer circuitry 806D to generate RF output signals for FEM circuitry 808. The baseband signals can be provided by baseband circuitry 804 and can be filtered by filter circuitry 806C. In some implementations, mixer circuitry 806A of the receive signal path and mixer circuitry 806A of the transmit signal path can include two or more mixers and can be arranged for quadrature down conversion and up conversion, respectively. In some implementations, mixer circuitry 806A of the receive signal path and mixer circuitry 806A of the transmit signal path can include two or more mixers and can be arranged for image rejection. In some implementations, mixer circuitry 806A of the receive signal path and mixer circuitry 806A can be arranged for direct down conversion and direct up conversion, respectively. In some implementations, mixer circuitry 806 of the receive signal path and mixer circuitry 806A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 806 can include analog-to-digital converter (ADC) and digital-to-analog converter (DAC) circuitry and baseband circuitry 804 can include a digital baseband interface to communicate with RF circuitry 806.

In some dual-mode implementations, a separate radio integrated circuitry can be provided for processing signals for each spectrum, although the scope of the implementations is not limited in this respect. In some implementations, synthesizer circuitry 806D can be a fractional-N synthesizer or a fractional N/N+1 synthesizer, although the scope of the implementations is not limited in this respect as other types of frequency synthesizers can be suitable. For example, synthesizer circuitry 806D can be a delta-sigma synthesizer, a frequency multiplier, or a synthesizer comprising a phase-locked loop with a frequency divider.

Synthesizer circuitry 806D can be configured to synthesize an output frequency for use by mixer circuitry 806A of RF circuitry 806 based on a frequency input and a divider control input. In some implementations, synthesizer circuitry 806D can be a fractional N/N+1 synthesizer. In some implementations, frequency input can be provided by a voltage-controlled oscillator (VCO). Divider control input can be provided by either baseband circuitry 804 or the applications circuitry 802 depending on the desired output frequency. In some implementations, a divider control input (e.g., N) can be determined from a look-up table based on a channel indicated by the applications circuitry 802.

Synthesizer circuitry 806D of RF circuitry 806 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 806D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 806 can include an in-phase/quadrature (I/Q)/polar converter.

FEM circuitry 808 can include a receive signal path which can include circuitry configured to operate on RF signals received from one or more antennas 810, amplify the received signals and provide the amplified versions of the received signals to RF circuitry 806 for further processing. FEM circuitry 808 can also include a transmit signal path which can include circuitry configured to amplify signals for transmission provided by RF circuitry 806 for transmission by one or more of the one or more antennas 810. In various implementations, the amplification through the transmit or receive signal paths can be done solely in RF circuitry 806, solely in FEM circuitry 808, or in both RF circuitry 806 and FEM circuitry 808.

In some implementations, FEM circuitry 808 can include a transmit/receive switch to switch between transmit mode and receive mode operation. FEM circuitry 808 can include a receive signal path and a transmit signal path. The receive signal path of FEM circuitry 808 can include a low noise amplifier to amplify received RF signals and provide the amplified received RF signals as an output (e.g., to RF circuitry 806). The transmit signal path of FEM circuitry 808 can include a power amplifier to amplify input RF signals (e.g., provided by RF circuitry 806), and one or more filters to generate RF signals for subsequent transmission (e.g., by one or more of one or more antennas 810).

In some implementations, PMC 812 can manage power provided to baseband circuitry 804. In particular, PMC 812 can control power-source selection, voltage scaling, battery charging, or direct current (DC) to DC (DC-to-DC) conversion. PMC 812 can often be included when device 800 is capable of being powered by a battery, for example, when device 800 is included in a UE. PMC 812 can increase the power conversion efficiency while providing desirable implementation size and heat dissipation characteristics.

While FIG. 8 shows PMC 812 coupled only with baseband circuitry 804. However, in other implementations, PMC 812 can be additionally or alternatively coupled with, and perform similar power management operations for, other components such as, but not limited to, application circuitry 802, RF circuitry 806, or FEM circuitry 808.

In some implementations, PMC 812 can control, or otherwise be part of, various power saving mechanisms of device 800. For example, if device 800 is in an RRC_Connected state, where device 800 is still connected to the RAN node as device 800 expects to receive traffic shortly, then device 800 can enter a state known as discontinuous reception mode (DRX) after a period of inactivity. During this state, device 800 can power down for brief intervals of time and thus save power.

If there is no data traffic activity for an extended period of time, then device 800 can transition off to an RRC_Idle state, where device 800 disconnects from the network and does not perform operations such as channel quality feedback, handover, etc. Device 800 can go into a very low power state and device 800 can perform paging where again device 800 periodically can wake up to listen to the network and then power down again. Device 800 may not receive data in this state; in order to receive data, device 800 can transition back to RRC_Connected state.

An additional power saving mode can allow a device to be unavailable to the network for periods longer than a paging interval (ranging from seconds to a few hours). During this time, the device 800 can be unreachable to the network and can power down completely. Any data sent during this time can incur a large delay and device 800 can assume the delay is acceptable.

Processors of application circuitry 802 and processors of baseband circuitry 804 can be used to execute elements of one or more instances of a protocol stack. For example, processors of baseband circuitry 804, alone or in combination, can be used execute Layer 3, Layer 2, or Layer 1 functionality, while processors of baseband circuitry 804 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

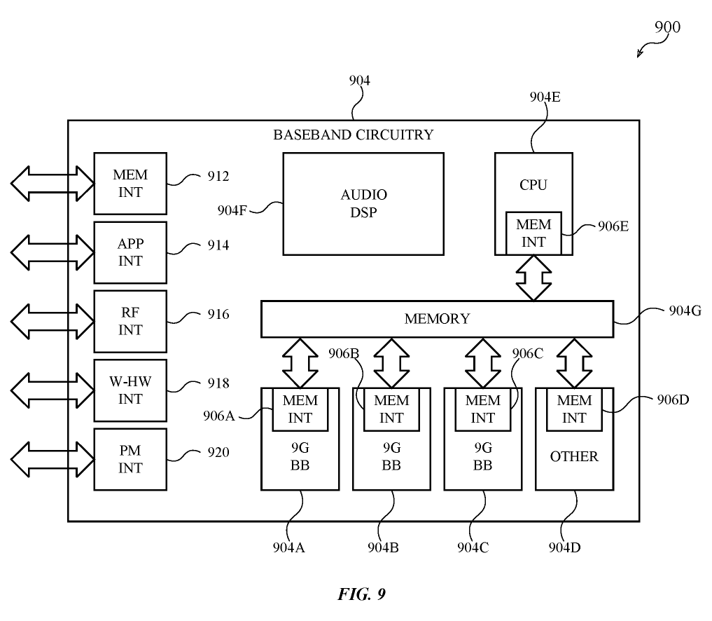

FIG. 9 is a diagram of example interfaces 900 of baseband circuitry configured to support CSI-RS resource setting according to one or more implementations described herein. One or more components or features of example interfaces 900 can correspond to one or more components or features described above or elsewhere. Baseband circuitry 904 can comprise processors 904A, 904B, 904C, 904D, and 904E and a memory 904G utilized by said processors. Each of processors 904A, 904B, 904C, 904D, and 904E can include a memory interface, 906A, 906B, 906C, 906D, and 906E, respectively, to send/receive data to/from memory 904G. Baseband circuitry can be a component of a UE and/or another type of device or system capable of transmitting and/or receiving wireless signals.

Baseband circuitry 904 can further include one or more interfaces to communicatively couple to other circuitries/devices, such as memory interface 912 (e.g., an interface to send/receive data to/from memory external to baseband circuitry 904), an application circuitry interface 914 (e.g., an interface to send/receive data to/from the application circuitry as described herein), an RF circuitry interface 916, a wireless hardware connectivity interface 918 (e.g., an interface to send/receive data to/from near field communication components, Bluetooth® components (e.g., Bluetooth® Low Energy), Wi-Fi® components, and other communication components), and a power management interface 920 (e.g., an interface to send/receive power or control signals to/from a PMC).

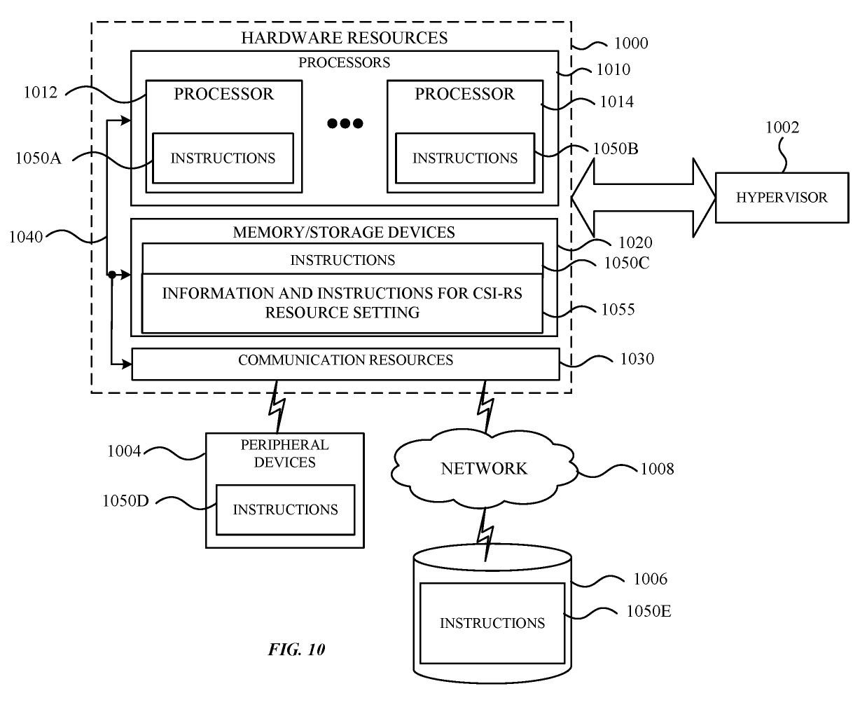

FIG. 10 is a block diagram illustrating components, according to one or more implementations described herein, able to read instructions from a machine-readable or computer-readable medium (e.g., a non-transitory machine-readable storage medium) and perform any one or more of the methodologies directed to CSI-RS resource setting, as discussed herein. Specifically, FIG. 10 shows a diagrammatic representation of hardware resources 1000 including one or more processors 1010 (or processor cores), one or more memory/storage devices 1020, and one or more communication resources 1030, each of which can be communicatively coupled via a bus 1040. For implementations where node virtualization or network function virtualization is utilized, a hypervisor can be executed to provide an execution environment for one or more network slices/sub-slices to utilize hardware resources 1000. Hardware resources 1000 can interact with hypervisor 1002. For example, hypervisor 1002 can schedule or otherwise manage hardware resource 1000.

Processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1012 and a processor 1014.

Memory/storage devices 1020 can include main memory, disk storage, or any suitable combination thereof. Memory/storage devices 1020 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 1020 receive and/or store information and instructions 1055 for CSI-RS resource setting as described herein. For example, the techniques described herein support communicating, between base station 222 and UE 210, one or more CSI-RSs in accordance with multiple CSI-RS resources mapped to a same OFDM symbol, based on using different frequencies. Likewise, different beams can be used for communicating during the same OFDM symbol, or across multiple OFDM symbols, which can support frequency selective beamforming techniques at base station 222 and UE 210. any other aspects and examples are also described herein.

Communication resources 1030 can include interconnection or network interface components or other suitable devices to communicate with one or more peripheral devices 1004 or one or more databases 1006 via a network 1008. For example, communication resources 1030 can include wired communication components (e.g., for coupling via a universal serial bus), cellular communication components, near field communication components, Bluetooth® components (e.g., Bluetooth® Low Energy), Wi-Fi® components, and other communication components.

Instructions 1050A, 1050B, 1050C, 1050D, and/or 1050E can comprise software, a program, an application, an applet, an app, or other executable code for causing at least any of processors 1010 to perform any one or more of the methodologies discussed herein. Instructions 1050 can reside, completely or partially, within at least one of processors 1010 (e.g., within a cache memory), memory/storage devices 1020, or any suitable combination thereof. Furthermore, any portion of instructions 1050A-1050Ecan be transferred to hardware resources 1000 from any combination of peripheral devices 1004 or databases 1006. Accordingly, memory of processors 1010, memory/storage devices 1020, peripheral devices 1004, and databases 1006 are examples of computer-readable and machine-readable media.

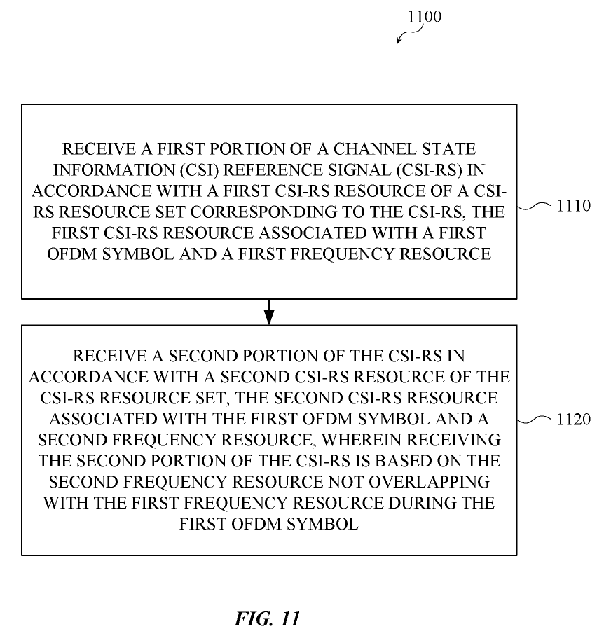

FIG. 11 is a diagram of an example process 1100 for CSI-RS resource setting according to one or more implementations described herein. As shown, process 1100 can be implemented by UE 210 and/or baseband circuitry 804. In some implementations, some or all of process 1100 can be performed by one or more other systems or devices, including one or more of the devices of FIG. 2. Additionally, process 1100 can include one or more fewer, additional, differently ordered and/or arranged operations than those shown in FIG. 11. In some implementations, some or all of the operations of process 1100 can be performed independently, successively, simultaneously, etc., of one or more of the other operations of process 1100. As such, the techniques described herein are not limited to the number, sequence, arrangement, timing, etc., of the operations or processes depicted in FIG. 11.

As shown, process 1100 can include receiving a first portion of a channel state information (CSI) reference signal (CSI-RS) in accordance with a first CSI-RS resource of a CSI-RS resource set corresponding to the CSI-RS, the first CSI-RS resource associated with a first OFDM symbol and a first frequency resource (block 1110).

Process 1100 can include receiving a second portion of the CSI-RS in accordance with a second CSI-RS resource of the CSI-RS resource set, the second CSI-RS resource associated with the first OFDM symbol and a second frequency resource, wherein receiving the second portion of the CSI-RS is based on the second frequency resource not overlapping with the first frequency resource during the first OFDM symbol (block 1120).

One or more of the examples described herein can also, or alternatively, be part of process 1100.

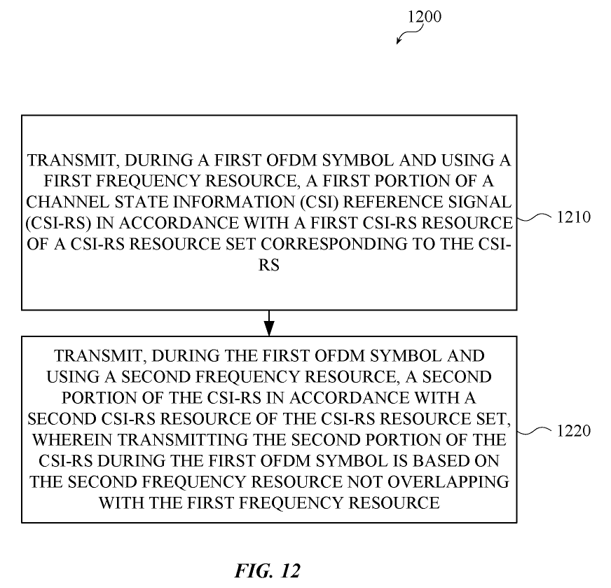

FIG. 12 is a diagram of an example process 1200 for CSI-RS resource setting according to one or more implementations described herein. As shown, process 1200 can be implemented by base station 222 or baseband circuitry 804. In some implementations, some or all of process 1200 can be performed by one or more other systems or devices, including one or more of the devices of FIG. 2. Additionally, process 1200 can include one or more fewer, additional, differently ordered and/or arranged operations than those shown in FIG. 12. In some implementations, some or all of the operations of process 1200 can be performed independently, successively, simultaneously, etc., of one or more of the other operations of process 1200. As such, the techniques described herein are not limited to the number, sequence, arrangement, timing, etc., of the operations or processes depicted in FIG. 12.

As shown, process 1200 can include transmitting, during a first OFDM symbol and using a first frequency resource, a first portion of a channel state information (CSI) reference signal (CSI-RS) in accordance with a first CSI-RS resource of a CSI-RS resource set corresponding to the CSI-RS (block 1210). Process 1200 can include transmitting, during the first OFDM symbol and using a second frequency resource, a second portion of the CSI-RS in accordance with a second CSI-RS resource of the CSI-RS resource set, wherein transmitting the second portion of the CSI-RS during the first OFDM symbol is based on the second frequency resource not overlapping with the first frequency resource (block 1220).

One or more of the examples described herein can also, or alternatively, be part of process 1200.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a base station can comprise: one or more processors configured to: transmit, during a first OFDM symbol and using a first frequency resource, a first portion of a channel state information (CSI) reference signal (CSI-RS) in accordance with a first CSI-RS resource of a CSI-RS resource set corresponding to the CSI-RS; and transmit, during the first OFDM symbol and using a second frequency resource, a second portion of the CSI-RS in accordance with a second CSI-RS resource of the CSI-RS resource set, wherein transmitting the second portion of the CSI-RS during the first OFDM symbol is based on the second frequency resource not overlapping with the first frequency resource.

In example 2, which can also include one or more of the examples described herein, the one or more processors are further configured to: transmit, during a second OFDM symbol and using the first frequency resource, a third portion of the CSI-RS in accordance with a third CSI-RS resource of the CSI-RS resource set, wherein transmitting the third portion of the CSI-RS using the first frequency resource is based on the second OFDM symbol occurring at a different time than the first OFDM symbol.

In example 3, which can also include one or more of the examples described herein, the one or more processors are further configured to: transmit, during a second OFDM symbol and using the second frequency resource, a fourth portion of the CSI-RS in accordance with a fourth CSI-RS resource of the CSI-RS resource set, wherein transmitting the fourth portion of the CSI-RS during the second OFDM symbol is based on the second frequency resource not overlapping with the first frequency resource.

In example 4, which can also include one or more of the examples described herein, the one or more processors are further configured to: transmit, during a second OFDM symbol and using the first frequency resource, a first portion of a second CSI-RS in accordance with a first CSI-RS resource of a second CSI-RS resource set corresponding to the second CSI-RS, wherein transmitting the first portion of the second CSI-RS using the first frequency resource is based on the second OFDM symbol occurring at a different time than the first OFDM symbol.

In example 5, which can also include one or more of the examples described herein, the one or more processors are further configured to: transmit, during the second OFDM symbol and using the second frequency resource, a second portion of the second CSI-RS in accordance with a second CSI-RS resource of the second CSI-RS resource set, wherein transmitting the second portion of the second CSI-RS during the second OFDM symbol is based on the second frequency resource not overlapping with the first frequency resource.

In example 6, which can also include one or more of the examples described herein, the one or more processors are further configured to: transmit, via a first beam, the first portion of the CSI-RS in accordance with a first beam configuration, the first beam configuration associated with using the first beam of a plurality of beams to transmit the first portion of the CSI-RS during the first OFDM symbol and using the first frequency resource.

In example 7, which can also include one or more of the examples described herein, the one or more processors are further configured to: transmit, via a second beam, the second portion of the CSI-RS in accordance with a second beam configuration, the second beam configuration associated with using the second beam of the plurality of beams to transmit the second portion of the CSI-RS during the first OFDM symbol and using the second frequency resource.

In example 8, which can also include one or more of the examples described herein, the one or more processors are further configured to: transmit, via a third beam, a third portion of the CSI-RS in accordance with a third beam configuration, the third beam configuration associated with using the third beam of the plurality of beams to transmit the third portion of the CSI-RS during a second OFDM symbol and using the first frequency resource.

In example 9, which can also include one or more of the examples described herein, the one or more processors are further configured to: transmit, via a fourth beam, a fourth portion of the CSI-RS in accordance with a fourth beam configuration, the fourth beam configuration associated with using the fourth beam of the plurality of beams to transmit the fourth portion of the CSI-RS during the second OFDM symbol and using the second frequency resource.

In example 10, which can also include one or more of the examples described herein, the one or more processors are further configured to: transmit, via the first beam, a third portion of the CSI-RS in accordance with the first beam configuration, wherein the third portion of the CSI-RS is transmitted during a second OFDM symbol and using the first frequency resource.

In example 11, which can also include one or more of the examples described herein, the one or more processors are further configured to: transmit, via the second beam, a fourth portion of the CSI-RS in accordance with the second beam configuration, wherein the fourth portion of the CSI-RS is transmitted during the second OFDM symbol and using the second frequency resource.

In example 12, which can also include one or more of the examples described herein, the one or more processors are further configured to: transmit, via a third beam, a third portion of the CSI-RS in accordance with a third beam configuration, the third beam configuration associated with using the third beam of the plurality of beams to transmit the third portion of the CSI-RS during a second OFDM symbol and using a third frequency resource in accordance with a third CSI-RS resource of the CSI-RS resource set.

In example 13, which can also include one or more of the examples described herein, the one or more processors are further configured to: transmit, via the first beam, the second portion of the CSI-RS in accordance with the first beam configuration, the first beam configuration associated with using the first beam to transmit the second portion of the CSI-RS during the first OFDM symbol and using the second frequency resource.

In example 14, which can also include one or more of the examples described herein, the one or more processors are further configured to: transmit, during the first OFDM symbol and using a third frequency resource, at least a portion of a synchronization signal block (SSB) in accordance with an SSB resource, wherein transmitting at least the portion of the SSB during the first OFDM symbol is based on the third frequency resource not overlapping with the first frequency resource and the second frequency resource.

In example 15, which can also include one or more of the examples described herein, the first frequency resource and the second frequency resource are defined relative to a frequency of a reference resource block (RB).

In example 16, which can also include one or more of the examples described herein, the first frequency resource is defined by a first offset applied to the frequency of the reference RB, and the second frequency resource is defined by a second offset applied to the frequency of the reference RB.

In example 17, which can also include one or more of the examples described herein, a magnitude of the first offset is a factor of a magnitude of the second offset, and the first offset and the second offset are equivalently spaced relative to the frequency of the reference RB.

In example 18, which can also include one or more of the examples described herein, a magnitude of the first offset is not a factor of a magnitude of the second offset, and the first offset and the second offset are independently configured relative to the frequency of the reference RB.

In example 19, which can also include one or more of the examples described herein, the one or more processors are further configured to: transmit, during a second OFDM symbol and using a third frequency resource, a third portion of the CSI-RS in accordance with a third CSI-RS resource of the CSI-RS resource set, wherein transmitting the third portion of the CSI-RS is based on the second OFDM symbol occurring at a different time than the first OFDM symbol and the third frequency resource not overlapping with the first frequency resource or the second frequency resource.

In example 20, which can also include one or more of the examples described herein, the third frequency resource is defined relative to a frequency of a second reference RB.

In example 21, which can also include one or more of the examples described herein, the first CSI-RS resource is associated with the first frequency resource based on the first CSI-RS resource being mapped to the first OFDM symbol, and the second CSI-RS resource is associated with the second frequency resource based on the second CSI-RS resource being mapped to the first OFDM symbol.

In example 22, which can also include one or more of the examples described herein, the one or more processors are further configured to: receive one or more CSI-RS reports based on transmitting the first portion of the CSI-RS and the second portion of the CSI-RS.

In example 23, which can also include one or more of the examples described herein, the one or more processors are further configured to: select a beam of a plurality of beams supported by the base station based on the one or more CSI-RS reports.

In example 24, which can also include one or more of the examples described herein, a UE can comprise: a memory storing one or more instructions; and one or more processors configured to, when executing the one or more instructions, cause the UE to: receive a first portion of a channel state information (CSI) reference signal (CSI-RS) in accordance with a first CSI-RS resource of a CSI-RS resource set corresponding to the CSI-RS, the first CSI-RS resource associated with a first OFDM symbol and a first frequency resource; and receive a second portion of the CSI-RS in accordance with a second CSI-RS resource of the CSI-RS resource set, the second CSI-RS resource associated with the first OFDM symbol and a second frequency resource, wherein receiving the second portion of the CSI-RS is based on the second frequency resource not overlapping with the first frequency resource during the first OFDM symbol.

In example 25, which can also include one or more of the examples described herein, when executing the one or more instructions, the one or more processors are further configured to: receive a third portion of the CSI-RS in accordance with a third CSI-RS resource of the CSI-RS resource set, the third CSI-RS resource associated with a second OFDM symbol and the first frequency resource, wherein receiving the third portion of the CSI-RS using the first frequency resource is based on the second OFDM symbol occurring at a different time than the first OFDM symbol.

In example 26, which can also include one or more of the examples described herein, when executing the one or more instructions, the one or more processors are further configured to: receive a fourth portion of the CSI-RS in accordance with a fourth CSI-RS resource of the CSI-RS resource set, the fourth CSI-RS resource associated with a second OFDM symbol and the second frequency resource, wherein receiving the fourth portion of the CSI-RS is based on the second frequency resource not overlapping with the first frequency resource during the second OFDM symbol.

In example 27, which can also include one or more of the examples described herein, when executing the one or more instructions, the one or more processors are further configured to: receive a first portion of a second CSI-RS in accordance with a first CSI-RS resource of a second CSI-RS resource set corresponding to the second CSI-RS, the first CSI-RS resource of the second CSI-RS resource set associated with a second OFDM symbol and the first frequency resource, wherein receiving the first portion of the second CSI-RS using the first frequency resource is based on the second OFDM symbol occurring at a different time than the first OFDM symbol.

In example 28, which can also include one or more of the examples described herein, when executing the one or more instructions, the one or more processors are further configured to: receive a second portion of the second CSI-RS in accordance with a second CSI-RS resource of the second CSI-RS resource set, the second CSI-RS resource of the second CSI-RS resource set associated with the second OFDM symbol and the second frequency resource, wherein receiving the second portion of the second CSI-RS is based on the second frequency resource not overlapping with the first frequency resource during the second OFDM symbol.

In example 29, which can also include one or more of the examples described herein, when executing the one or more instructions, the one or more processors are further configured to: receive, via a first transmission beam, the first portion of the CSI-RS in accordance with a first beam configuration, the first beam configuration associated with using the first transmission beam of a plurality of transmission beams to transmit the first portion of the CSI-RS during the first OFDM symbol and using the first frequency resource.

In example 30, which can also include one or more of the examples described herein, when executing the one or more instructions, the one or more processors are further configured to: receive, via a second transmission beam, the second portion of the CSI-RS in accordance with a second beam configuration, the second beam configuration associated with using the second transmission beam of the plurality of transmission beams to transmit the second portion of the CSI-RS during the first OFDM symbol and using the second frequency resource.

In example 31, which can also include one or more of the examples described herein, when executing the one or more instructions, the one or more processors are further configured to: receive, via a third transmission beam, a third portion of the CSI-RS in accordance with a third beam configuration, the third beam configuration associated with using the third transmission beam of the plurality of transmission beams to transmit the third portion of the CSI-RS during a second OFDM symbol and using the first frequency resource.

In example 32, which can also include one or more of the examples described herein, when executing the one or more instructions, the one or more processors are further configured to: receive, via a fourth transmission beam, a fourth portion of the CSI-RS in accordance with a fourth beam configuration, the fourth beam configuration associated with using the fourth transmission beam of the plurality of transmission beams to transmit the fourth portion of the CSI-RS during the second OFDM symbol and using the second frequency resource.

In example 33, which can also include one or more of the examples described herein, when executing the one or more instructions, the one or more processors are further configured to: receive, via the first transmission beam, a third portion of the CSI-RS in accordance with the first beam configuration, wherein the third portion of the CSI-RS is associated with a second OFDM symbol and the first frequency resource.

In example 34, which can also include one or more of the examples described herein, when executing the one or more instructions, the one or more processors are further configured to: receive, via the second transmission beam, a fourth portion of the CSI-RS in accordance with the second beam configuration, wherein the fourth portion of the CSI-RS is associated with the second OFDM symbol and using the second frequency resource.

In example 35, which can also include one or more of the examples described herein, when executing the one or more instructions, the one or more processors are further configured to: receive, via a third transmission beam, a third portion of the CSI-RS in accordance with a third beam configuration, the third beam configuration associated with using the third transmission beam of the plurality of transmission beams to transmit the third portion of the CSI-RS during a second OFDM symbol and using a third frequency resource in accordance with a third CSI-RS resource of the CSI-RS resource set.

In example 36, which can also include one or more of the examples described herein, when executing the one or more instructions, the one or more processors are further configured to: receive, via the first transmission beam, the second portion of the CSI-RS in accordance with the first beam configuration, the first beam configuration associated with using the first transmission beam to transmit the second portion of the CSI-RS during the first OFDM symbol and using the second frequency resource.

In example 37, which can also include one or more of the examples described herein, when executing the one or more instructions, the one or more processors are further configured to: receive at least a portion of a synchronization signal block (SSB) in accordance with an SSB resource associated with the first OFDM symbol and a third frequency resource.

In example 38, which can also include one or more of the examples described herein, the first frequency resource and the second frequency resource are defined relative to a frequency of a reference resource block (RB).

In example 39, which can also include one or more of the examples described herein, the first frequency resource is defined by a first offset applied to the frequency of the reference RB, and the second frequency resource is defined by a second offset applied to the frequency of the reference RB.

In example 40, which can also include one or more of the examples described herein, a magnitude of the first offset is a factor of a magnitude of the second offset, and the first offset and the second offset are equivalently spaced relative to the frequency of the reference RB.

In example 41, which can also include one or more of the examples described herein, a magnitude of the first offset is not a factor of a magnitude of the second offset, and the first offset and the second offset are independently configured relative to the frequency of the reference RB.

In example 42, which can also include one or more of the examples described herein, when executing the one or more instructions, the one or more processors are further configured to: receive a third portion of the CSI-RS in accordance with a third CSI-RS resource of the CSI-RS resource set, the third CSI-RS resource associated with a second OFDM symbol and a third frequency resource, wherein receiving the third portion of the CSI-RS is based on the second OFDM symbol occurring at a different time than the first OFDM symbol and the third frequency resource not overlapping with the first frequency resource or the second frequency resource.

In example 43, which can also include one or more of the examples described herein, the third frequency resource is defined relative to a frequency of a second reference RB.

In example 44, which can also include one or more of the examples described herein, the first CSI-RS resource is associated with the first frequency resource based on the first CSI-RS resource being mapped to the first OFDM symbol, and the second CSI-RS resource is associated with the second frequency resource based on the second CSI-RS resource being mapped to the first OFDM symbol.

In example 45, which can also include one or more of the examples described herein, when executing the one or more instructions, the one or more processors are further configured to: perform CSI-RS measurement based on receiving the first portion of the CSI-RS and the second portion of the CSI-RS; determine CSI based on performing the CSI-RS measurement; and transmit one or more CSI-RS reports based on determining the CSI.

In example 46, which can also include one or more of the examples described herein, when executing the one or more instructions, the one or more processors are further configured to: select a beam of a plurality of beams supported by the UE based on performing the CSI-RS measurement.

In example 47, which can also include one or more of the examples described herein, can include a method performed by one or more of a base station, UE, and/or baseband circuitry.

In example 48, which can also include one or more of the examples described herein, can include a computer-readable medium configured to store instructions that when executed by one or more processor can cause the one or more processors to perform one or more of the operations described herein.

References herein to a first frequency resource can refer to up to four frequency resources. References herein to a second frequency resource can refer to up to four frequency resources. References herein to a third frequency resource can refer to up to four frequency resources. References herein to a fourth frequency resource can refer to up to four frequency resources.

The above description of illustrated examples, implementations, aspects, etc., of the above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A base station comprising:
one or more processors configured to:
transmit, during a first orthogonal frequency division multiplexing (OFDM) symbol and using a first frequency resource, a first portion of a channel state information (CSI) reference signal (CSI-RS) in accordance with a first CSI-RS resource of a CSI-RS resource set corresponding to the CSI-RS; and
transmit, during the first OFDM symbol and using a second frequency resource, a second portion of the CSI-RS in accordance with a second CSI-RS resource of the CSI-RS resource set, wherein transmitting the second portion of the CSI-RS during the first OFDM symbol is based on the second frequency resource not overlapping with the first frequency resource.

2. The base station of claim 1, wherein the one or more processors are further configured to:
transmit, during a second OFDM symbol and using the first frequency resource, a third portion of the CSI-RS in accordance with a third CSI-RS resource of the CSI-RS resource set, wherein transmitting the third portion of the CSI-RS using the first frequency resource is based on the second OFDM symbol occurring at a different time than the first OFDM symbol.

3. The base station of claim 2, wherein the one or more processors are further configured to:
transmit, during a second OFDM symbol and using the second frequency resource, a fourth portion of the CSI-RS in accordance with a fourth CSI-RS resource of the CSI-RS resource set, wherein transmitting the fourth portion of the CSI-RS during the second OFDM symbol is based on the second frequency resource not overlapping with the first frequency resource.

4. The base station of claim 1, wherein the one or more processors are further configured to:
transmit, during a second OFDM symbol and using the first frequency resource, a first portion of a second CSI-RS in accordance with a first CSI-RS resource of a second CSI-RS resource set corresponding to the second CSI-RS, wherein transmitting the first portion of the second CSI-RS using the first frequency resource is based on the second OFDM symbol occurring at a different time than the first OFDM symbol.

5. The base station of claim 4, wherein the one or more processors are further configured to:
transmit, during the second OFDM symbol and using the second frequency resource, a second portion of the second CSI-RS in accordance with a second CSI-RS resource of the second CSI-RS resource set, wherein transmitting the second portion of the second CSI-RS during the second OFDM symbol is based on the second frequency resource not overlapping with the first frequency resource.

6. The base station of claim 1, wherein the one or more processors are further configured to:
transmit, via a first beam, the first portion of the CSI-RS in accordance with a first beam configuration, the first beam configuration associated with using the first beam of a plurality of beams to transmit the first portion of the CSI-RS during the first OFDM symbol and using the first frequency resource.

7. The base station of claim 6, wherein the one or more processors are further configured to:
transmit, via a second beam, the second portion of the CSI-RS in accordance with a second beam configuration, the second beam configuration associated with using the second beam of the plurality of beams to transmit the second portion of the CSI-RS during the first OFDM symbol and using the second frequency resource.

8. The base station of claim 7, wherein the one or more processors are further configured to:
transmit, via a third beam, a third portion of the CSI-RS in accordance with a third beam configuration, the third beam configuration associated with using the third beam of the plurality of beams to transmit the third portion of the CSI-RS during a second OFDM symbol and using the first frequency resource.

9. The base station of claim 8, wherein the one or more processors are further configured to:
transmit, via a fourth beam, a fourth portion of the CSI-RS in accordance with a fourth beam configuration, the fourth beam configuration associated with using the fourth beam of the plurality of beams to transmit the fourth portion of the CSI-RS during the second OFDM symbol and using the second frequency resource.

10. The base station of claim 7, wherein the one or more processors are further configured to:
transmit, via the first beam, a third portion of the CSI-RS in accordance with the first beam configuration, wherein the third portion of the CSI-RS is transmitted during a second OFDM symbol and using the first frequency resource.

11. The base station of claim 10, wherein the one or more processors are further configured to:
transmit, via the second beam, a fourth portion of the CSI-RS in accordance with the second beam configuration, wherein the fourth portion of the CSI-RS is transmitted during the second OFDM symbol and using the second frequency resource.

12. The base station of claim 7, wherein the one or more processors are further configured to:
transmit, via a third beam, a third portion of the CSI-RS in accordance with a third beam configuration, the third beam configuration associated with using the third beam of the plurality of beams to transmit the third portion of the CSI-RS during a second OFDM symbol and using a third frequency resource in accordance with a third CSI-RS resource of the CSI-RS resource set.

13. The base station of claim 6, wherein the one or more processors are further configured to:
transmit, via the first beam, the second portion of the CSI-RS in accordance with the first beam configuration, the first beam configuration associated with using the first beam to transmit the second portion of the CSI-RS during the first OFDM symbol and using the second frequency resource.

14. The base station of claim 1, wherein the one or more processors are further configured to:
transmit, during the first OFDM symbol and using a third frequency resource, at least a portion of a synchronization signal block (SSB) in accordance with an SSB resource, wherein transmitting at least the portion of the SSB during the first OFDM symbol is based on the third frequency resource not overlapping with the first frequency resource and the second frequency resource.

15. The base station of claim 1, wherein the first frequency resource and the second frequency resource are defined relative to a frequency of a reference resource block (RB).

16. The base station of claim 15, wherein the first frequency resource is defined by a first offset applied to the frequency of the reference RB, and the second frequency resource is defined by a second offset applied to the frequency of the reference RB.

17. A user equipment (UE) comprising:
a memory storing one or more instructions; and
one or more processors configured to, when executing the one or more instructions, cause the UE to:
receive a first portion of a channel state information (CSI) reference signal (CSI-RS) in accordance with a first CSI-RS resource of a CSI-RS resource set corresponding to the CSI-RS, the first CSI-RS resource associated with a first orthogonal frequency division multiplexing (OFDM) symbol and a first frequency resource; and
receive a second portion of the CSI-RS in accordance with a second CSI-RS resource of the CSI-RS resource set, the second CSI-RS resource associated with the first OFDM symbol and a second frequency resource, wherein receiving the second portion of the CSI-RS is based on the second frequency resource not overlapping with the first frequency resource during the first OFDM symbol.

18. The UE of claim 17, wherein, when executing the one or more instructions, the one or more processors are further configured to:
receive a third portion of the CSI-RS in accordance with a third CSI-RS resource of the CSI-RS resource set, the third CSI-RS resource associated with a second OFDM symbol and the first frequency resource, wherein receiving the third portion of the CSI-RS using the first frequency resource is based on the second OFDM symbol occurring at a different time than the first OFDM symbol.

19. Baseband circuitry, comprising:
a memory storing one or more instructions; and
one or more processors configured to, when executing the one or more instructions, cause the baseband circuitry to:
receive a first portion of a channel state information (CSI) reference signal (CSI-RS) in accordance with a first CSI-RS resource of a CSI-RS resource set corresponding to the CSI-RS, the first CSI-RS resource associated with a first orthogonal frequency division multiplexing (OFDM) symbol and a first frequency resource; and
receive a second portion of the CSI-RS in accordance with a second CSI-RS resource of the CSI-RS resource set, the second CSI-RS resource associated with the first OFDM symbol and a second frequency resource, wherein receiving the second portion of the CSI-RS is based on the second frequency resource not overlapping with the first frequency resource during the first OFDM symbol.

20. The baseband circuitry of claim 19, wherein, when executing the one or more instructions, the one or more processors are further configured to cause the baseband circuitry to:
receive a first portion of a second CSI-RS in accordance with a first CSI-RS resource of a second CSI-RS resource set corresponding to the second CSI-RS, the first CSI-RS resource of the second CSI-RS resource set associated with a second OFDM symbol and the first frequency resource, wherein receiving the first portion of the second CSI-RS using the first frequency resource is based on the second OFDM symbol occurring at a different time than the first OFDM symbol.
